(19) United States
(12) Patent Application Publication
(10) Pub. No.: US 2002/0069157 A1
(43) Pub. Date: Jun. 6, 2002

(54) Exchange fusion

(76) Inventor: Michael S. Jordan, Marietta, GA (US)

Correspondence Address: PENNIE AND EDMONDS, 1155 AVENUE OF THE AMERICAS, NEW YORK, NY, 100362711

(21) Appl. No.: 09/957,700

(22) Filed: Sep. 17, 2001

Related U.S. Application Data
(60) Provisional application No. 60/232,878, filed on Sep. 15, 2000.
(60) Provisional application No. 60/233,098, filed on Sep. 15, 2000.

(51) Int. Cl. G06F 17/60

(52) U.S. Cl. 705/37

(57) ABSTRACT

A system and method are disclosed for coordinating an auction for an item between a multi-auction service, a plurality of remote auction services, and a plurality of bidders, all of which are interconnected by a network. The multi-auction service performing the steps of receiving selling parameters for the item to be auctioned from a seller, transmitting the parameters for the item to a plurality of remote auction services, throughout the auction detecting that a bid for the item has been received by at least one of the remote auction services, determining which of the remote auction services should receive a replicated bid, and transmitting a replicated bid to each of the remote auction services so determined. A second embodiment of the invention describes the method wherein more than one remote auction service receives a bid for the item, and wherein the multi-auction service detects that a bid for the item has been received by more than one of the remote auction services, establishes which of the received bids is an optimal bid for the item, and transmits the optimal bid as the replicated bid to each of the remote auction services.

### CROSS REFERENCE TO RELATED APPLICATIONS

This application claims priority of provisional application number 60/232,878 filed on Sep. 15, 2000 and provisional application number 60/233,098 filed on Sep. 15, 2000.

### FIELD OF THE INVENTION

This invention relates to systems and methods for creating distributed dynamic trade relationships among digital exchanges and auction sites.

### BACKGROUND OF THE INVENTION

The present invention relates to auction systems where a user specifies parameters of an item for sale in the auction system and where bidders submit offers for the items for auction.

Prior art electronic auction systems on the World Wide Web have implemented a similar methodology to allow more widespread visibility of items to be auctioned to allow sellers to submit items for auction on-line where user's bids from around the world may be received and recorded as the auction progresses. The seller contacts an auction service to indicate that an item is available for sale. The seller identifies the items and specifies the parameters of the auction. The actual auction process is executed by the auction service in accordance with the seller or auctioneer specified rules for the auction of that item. The item does not have to be located where the auction is run, but in order to guarantee the integrity of the auction so that the winning bidder is able to purchase the item, the auction service must have the exclusive right to offer the item. When the auction is over, the highest bidder is contacted and the goods are shipped from the seller to the highest bidder. The terms for the sale are specified in the auction, but the coordination of the shipping is usually arranged between the buyer and seller although some sites provide shipping as an extra service.

In order for a seller to use the auction site, the seller must register and provide an item description. The auction sites may require that sellers provide some means of authentication that the items represented are of the quality described. Different auction sites may have different forms of verification or may require that the item be submitted or shipped to the auction site prior to auction. For those sites that do not require shipping the product prior to auction, the shipping of the product may be arranged between the seller and the buyer or facilitated by the auction service.

While these auction sites provide a means for sellers to offer goods for sale, the seller has to determine the single best auction site for the product to be sold. The seller may receive substantially more or less than expected depending on the number of bidders and what they are willing to pay. The seller can not list an item on more than one site because the winning bidder in each auction rightfully expects to be able to buy the item, of which the seller has only one. Unless a seller is willing to “default”, the seller is currently limited to choosing a single auction site for any particular item. It is therefore to the benefit of the seller to choose the best auction site for that type of product. The best site may be the site that has the most user traffic, or it may be a specialized site that offers items for sale in limited classes of products. For example, a coin collector could offer a highly desirable coin for sale at a general auction site such as eBay, or alternatively the coin collector may choose to place the coin at an auction site that caters to knowledgeable coin buyers. Other services may be provided to show the seller the price of similar products. This may require the seller to investigate different web sites to determine which auction site has the most traffic or has sold similar items at the highest price.

The final sale price is ultimately dependent on the number of bidders for a product at that site and the visibility of that item among all the items being offered at that site. A seller hoping to receive the highest price is therefore limited to the users accessing that web site that are bidding on that product. Auction services have provided users with different means to increase the visibility of the item to be sold by establishing classification methods that allow the user's item to be more frequently retrieved by the search engine. The user typically pays an added amount for preferred placement of their item on the web pages generated. These aspects of placement, while providing better visibility on that web site do not offer the visibility beyond that auction server.

U.S. Pat. No. 5,835,896, METHOD AND SYSTEM FOR PROCESSING AND TRANSMITTING ELECTRONIC AUCTION INFORMATION, assigned to OnSale Inc., discloses an automated system used for auctions on the Internet where the buyer submits bids to the system which validates the bids and ultimately notifies the successful bidder(s) when the auction is over. During the auction process, the server updates the page image stored on the server so new users requesting the page see the most recent bid information. Recently outbid users are notified via email of higher bids. Users may also be represented by automated processes that bid incrementally in an automated fashion up to a predefined user specified value. Different auction types are supported such as Standard Auction, Dutch Auction, and Progressive Auction. A bid closing process called “Floating Closing Time” is additionally disclosed whereby inactivity for a period of time will end the auction of the item prior to the fixed closing time specified in the auction.

U.S. Pat. No. 5,890,138 COMPUTER AUCTION SYSTEM, assigned to Bid.Com International Inc., discloses another Internet based auction system where users access a central database of products to purchase items from a quantity of similar items. The timeframe of the offer is strictly controlled and a number of items are offered where the price decreases until all of the items are sold or until the timeframe of the sale expires. The system updates the displayed availability information at periodic intervals where the period is shortened as the sale comes to an end.

U.S. Pat. No. 5,905,975, COMPUTER IMPLEMENTED METHODS AND APPARATUS FOR AUCTIONS, discloses an auction system where users may define bidding rules that are subsequently enforced throughout the bidding process for an item, thus allowing users to control the amount of time that they are required to devote to the bidding process. The user's system and the auctioneers system communicate automatically to determine how the bidding is incremented according to the rules defined. Complex rules may be implemented where the user may specify quantities of an item to be purchased at various prices.

What is desired therefore is a methodology of placing an item for auction that has access to and is visible through more than one auction service at the same time where the bids received by any of the auction services affect and are coordinated with each other, such that each service receives and reflects the highest price for that item received by any of the participating auction services.

The objective of the invention is to provide increased visibility of an item to be auctioned by mirroring the item to be offered through a plurality of remote auction services simultaneously whether these services are computerized (e.g., eBay, OnSale.com, etc.) or manually operated (e.g. Sotherby's, Christie's, etc.). As the auction progresses, when a user bid is entered at one site or service, it is duplicated at the other sites or services where the item has been listed. The server process watches each site and creates a bid on the other sites in real-time that corresponds to the bid made at the first site. The bid replication technology revealed here assures that when the auctions are closed, the winning bid is the same at all sites, and that each bidder who has a right to purchase the item in question can be satisfied. By increasing the number of bids for an item and replicating bids across sites, the price will rise because bidders must compete against other bidders not only at their site, but at all sites on which the item is offered. By listing the item on multiple sites, the seller is gaining visibility for the item and has the most potential to receive the highest ultimate price.

It is also desirable to use the functionality of the service of this invention to provide an optimized method for a bidder to have the multi-auction service place coordinated bids at one or more of a plurality of networked remote auction services for a bidder to enable him to purchase those items a the optimal or lowest prices from the point of view of the bidder. Prior electronic art provides means for a bidder to have an agent generate automatic bids according to pre-specified rules, which may be complex. However, each set of rules applies only to a single auction and considers bidding activity in only that auction. Contemporaneous bidding activity related to identical items, or similar items which are viable substitutes, occurring at other auctions are not considered. The service of this invention allows a bidder to place an order with the multi-auction service and have the multi-auction service coordinate a bidding strategy for an item or items across remote auction services in order to achieve an optimal result.

### SUMMARY OF THE INVENTION

A system and method are disclosed for coordinating an auction for an item between a multi-auction service, a plurality of remote auction services, and a plurality of bidders, all of which are interconnected by a network. The multi-auction service performing the steps of receiving selling parameters for the item to be auctioned from a seller, transmitting the parameters for the item to a plurality of remote auction services, throughout the auction detecting that a bid for the item has been received by at least one of the remote auction services, determining which of the remote auction services should receive a replicated bid, and transmitting a replicated bid to each of the remote auction services so determined. A second embodiment of the invention describes the method wherein more than one remote auction service receives a bid for the item, and wherein the multi-auction service detects that a bid for the item has been received by more than one of the remote auction services, establishes which of the received bids is an optimal bid for the item, and transmits the optimal bid as the replicated bid to each of the remote auction services.

A networked system is described for coordinating the sale of an item to an optimal bidder across a plurality of remote auction services, where the system comprises a networked multi-auction service system, a plurality of networked remote auction services, and a plurality of bidders. The multi-auction service comprises means for communicating with the plurality of remote auction services, means for replicating the item to be auctioned at the plurality of networked remote auction services, means for detecting a plurality of bids from a plurality of remote auction services, means for determining which of said plurality of detected bids is the optimal bid, and means for replicating the optimal bid across the plurality of remote auction services.

The remote auction services each comprise means for receiving selling parameters for the item to be auctioned from the multi-auction service, means for receiving bids for the item to be auctioned from the plurality of bidders and said multi-auction service, and means for updating the bid for the item to be auctioned.

Each of the plurality of bidders comprises means for bidding on the item to be auctioned at one of the remote auction services.

A method is additionally disclosed for allowing a bidder to communicate with a multi-auction service to request the multi-auction service to selectively place coordinated bids at one or more remote auction service(s) for a plurality of items where one item is desired. This method comprises the bidder specifying to the multi-auction service the item type to be bid upon, the bidder specifying to the multi-auction service the rules for bidding, the bidder or the multi-auction service determining which items at the remote auction services match the bidder requested item, the multi-auction service periodically checking each of the remote auction sites to determine which site and item to bid on, and the multi-auction service placing bids on the item specified at the remote auction services such that a unique and optimal bid is active at only one of the remote auction services at a moment in time and is placed according to the bidder specified rules. In another embodiment, the bidder may specify rules regarding the bidders preference for one or more of identical, or similar, items sought.

### BRIEF DESCRIPTION OF DRAWINGS

These and other objects, features and advantages the invention will be more readily apparent from the following detailed description in which:

FIG. 1 is a schematic illustration of the auction of the present invention;

FIG. 2 is a depiction of an illustrative Log in screen;

FIG. 3 is a depiction of an illustrative Registration screen;

FIG. 4 is a depiction of an illustrative Partner Exchange menu;

FIG. 5 is a depiction of an illustrative Seller's screen;

FIG. 6 is a schematic illustration of the Buyer identification process;

FIG. 7 is a schematic illustration of an XML SQL Utility;

FIG. 8 is a schematic illustration of the processing of SQL utilities by the XML SQL Utility;

FIG. 9 is a schematic illustration of the operation of XML Parsers;

FIG. 10 is a schematic illustration depicting an XML data exchange;

FIG. 11 is a schematic illustration of the use of an XSL Stylesheet to transform an XML document;

FIG. 12 is a schematic illustration of a JAVA Class Generator;

FIG. 13 is a schematic illustration of an implementation of a JAVA XSQL Servlet;

FIG. 14 is a hub and spoke model of an illustrative messaging system architecture;

FIG. 15 is a schematic illustration of a message broker;

FIG. 16 is a schematic illustration of a publish and subscribe method;

FIG. 17 is a schematic illustration of a Queue Table Structure;

FIG. 18 is a block diagram of an illustrative embodiment of the invention;

FIG. 19 is a schematic illustration of a transaction network of the present invention; and

FIG. 20 is a schematic illustration of a detail of the transaction network.

### DESCRIPTION OF EXAMPLE CODE

Example CodeA: Template-Driven Mapping

Example Code1: Generating XML from Query Results and Structuring the Data

Example Code2: Writing XML to a Database Table

Example Code3: XML Parsing

Example Code3a: XML Class Generator For Java

Example Code3b: Processing the DTD to Generate Java Classes

Example Code3c: Creating a Valid XML Document from Java Classes

Example Code3d: XML Document Created by Java Application

Example Code3e: XSQL Servlet. 29

Example Code4: JMS syntax for creating a session on an established connection

Example Code4a: Pub/Sub Me 38

Example Code5: Processing System Messages

Example Code6: Handling Messages with a Servlet

Example Code7: Sending an email notification to a client application

### DETAILED DESCRIPTION OF THE INVENTION

The present invention relates to a forward auction or reverse auction that is created once on a host exchange, or “primary exchange,” and then simultaneously created or replicated on other “partner exchanges” in order to form a MetaAuction or “joined market.” A MetaAuction promotes a non-linear (open system) relationship between buyers and sellers that spans across two or more exchanges having varied technology platforms to effectively form a single, unified auction that enables buyers and sellers in different exchanges to participate in the auction. A MetaAuction allows users to see the exact same auction in all of the participating exchanges regardless of where the auction or bids originate from. Any event such as a new or modified bid in one exchange is also simultaneously seen in the other partner exchanges. That is, when a bid is placed or modified on one of the exchanges comprising the MetaAuction, the bid is also seen immediately on the other “partner exchanges.” The same would be true if the seller modified the auction in some way - the auction would be modified in the other exchanges as well. In short, any event that occurs to the MetaAuction in any of the partner exchanges, either by seller or buyers, is immediately reflected in the other exchanges to form a uniform, contiguous transaction.

A MetaAuction utilizes both synchronous and asynchronous connection protocols, using an open system approach to achieve a distributed communications framework. “Partner exchanges” that form MetaAuctions do not have to be on the same technology platform. The interaction of technology infrastructures between exchanges can be invasive or non-invasive.

NOTE: Unless stated otherwise, the term “exchange” is synonymous with “auction site.”

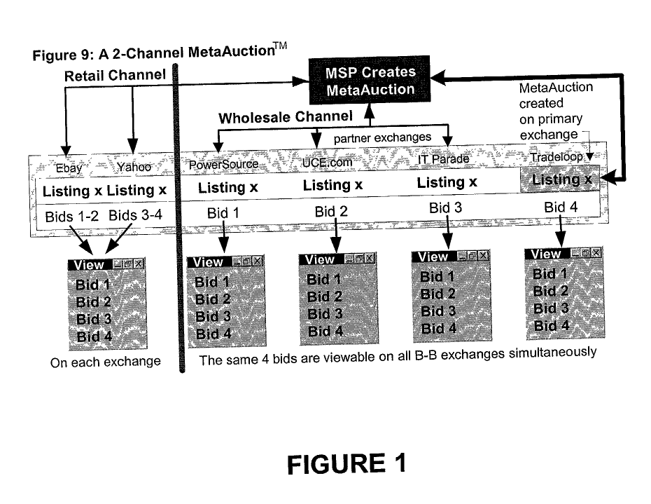

A “Meta-Infrastructure Service Provider” or “MSP” creates the necessary meta-infrastructure to facilitate the creation and maintenance of MetaAuctions. The MSP acts as a routing station to distribute, synchronize and buffer information flow between exchanges without compromising the proprietary user information of each partner exchange. That is, the MSP is a trusted third party service provider charged with the segregation and protection of proprietary user information belonging to each partner exchange during the MetaAuction process. This allows exchanges in the same vertical market space to offer sellers greater market exposure for their auctions and offer buyers a greater diversification of auctions from which to choose. For sellers, this means accessing a greater portion of the available “whole” market resulting in more potential sales at a lower cost. For buyers, this means having more auctions to choose from and more competition among sellers, which results in lower product acquisition cost for them. In this case, the function of the MSP is to be a “transparent enabler” of distributed commerce transactions for exchanges. See for example, FIG. 1.

Meta-infrastructure is provided as a utility service that is managed by a MSP either centrally or in a distributed fashion.

The MSP is an “agent in the middle” entity that networks multiple exchanges and auction sites together in order to facilitate MetaAuctions within the network. An exchange or auction site that wishes to connect to other exchanges in this way will find a MSP attractive for several reasons:

Service increases retention of sellers by resolving transactional fragmentation

Offers pre-established arrangements with other competitive exchanges

Is a third party trusted to buffer proprietary user information between exchanges

Monitors exchanges for structural changes and corrects accordingly

Handles fee settlements between exchanges

Service is “plug and play” and accessible immediately

Service offers immediate “virtual market liquidity” to exchanges

Increases exchange revenue via increased bid yield

This MSP creates a meta-transactional network (MTN) or “transaction highway” among the exchanges and auction sites it services. By definition, a MTN is created when at least two exchanges or auction sites are connected via meta-infrastructure, whether facilitated by MSP or software. MTN's then become vertically oriented exchange clusters that can be public or private.

Competition and vertical market specialization are likely to create multiple MSP's. The resulting MTN's can be bridged together to form MTN clusters.

The service facilitates various MetaAuction relationships that can be buffered or non-buffered (shared):

Auction site-to-Exchange

Exchange-to-Auction Site

Exchange-to-Exchange

Creation of Meta-Transactional Networks (MTN's)

The service allows an auction to cross or extend over many disparate exchanges and/or auction sites to form a single, congruent auction-type listing. This solves the problems of transactional fragmentation and vertical fragmentation and also enables the formation of new e-commerce relationships among auction sites and exchanges that are not possible without the use of MetaAuction methodology.

### DETAILED DESCRIPTION OF THE INVENTION

Definition of Terms

Client—Exchange or auction site or any site engaged utilizing auctions or dynamic commerce methods to interact with buyers and sellers.

The Service—Refers to the functionality of the MSP as a transparent enabler of MetaAuctions; a third party utility service that provides MetaAuction capability.

CMTN—Centralized meta-transactional network.

DMTN—Distributed meta-transactional network.

User—Primary users and secondary users. Also called “client user.”

Primary User—Originator of MetaAuction (reverse or forward) on the primary exchange.

Secondary-User—MetaAuction participant (buyer or seller) on partner exchange. Secondary users on primary exchange are excluded.

MSP—Synonymous with the service; a “Meta-Infrastructure Service Provider”

MSP OR/DBMS—The object-relational database management system used by MSP.

Accepted Secondary User—A secondary user

The System—Refers to the meta-infrastructure processes and all middleware components; the meta-infrastructure.

Functional process of the service (user/client interfaces and experiences)

User/client interfaces and user/client experiences can be expressed in a multitude of ways. The ideal expression is for the service to function seamlessly between clients so that users experience MetaAuctions via the client's normal GUI. That is, MetaAuctions become seamless across clients.

I. User Sequence 1 (us1/): Setup of MetaAuction by Primary User on Primary Client

<pfx=Primary User Function, where x is the sequential function number>

us1/pf1: “Create MetaAuction” button clicked on primary client. Primary client creates an auction internally in the normal manner.

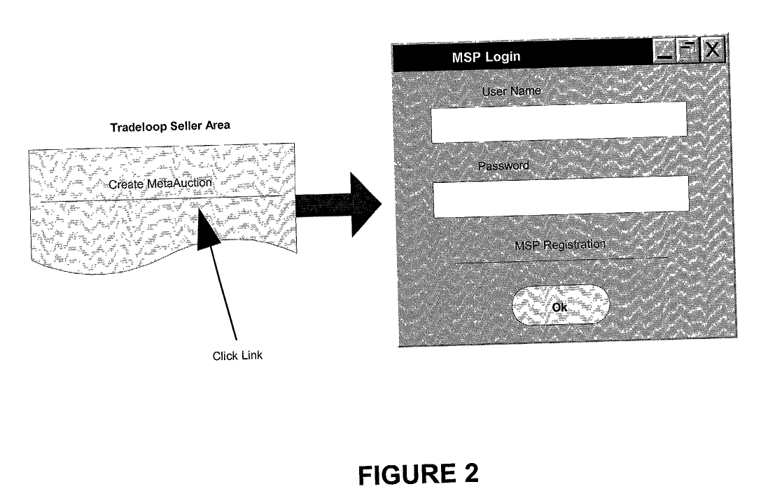

us1/pf2: Primary user presented with a “MSP Login” pop-up window (window triggered by us1/pf1). See FIG. 2.

us1/pf3c: If “MSP Registration” link clicked on “MSP Login” window, then primary user is presented with the “MSP Registration” pop-up window.

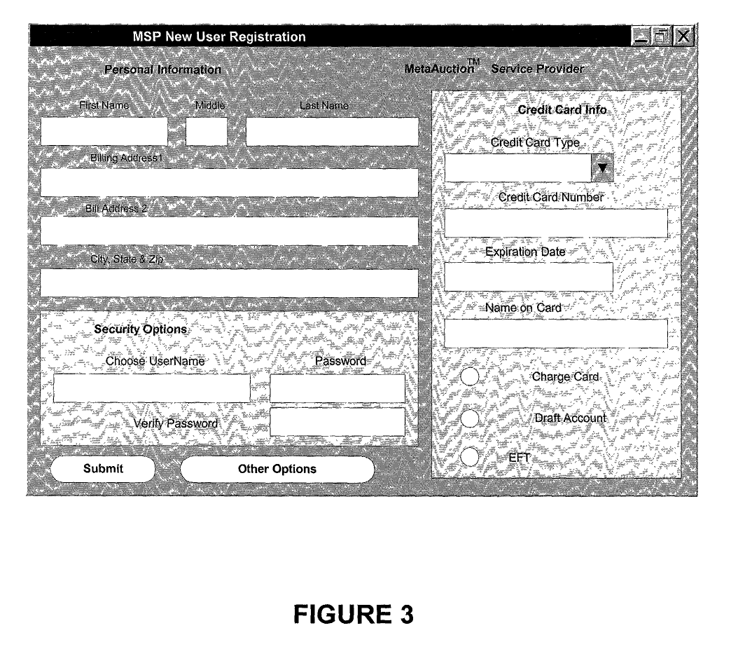

NOTE: The service uses synchronous and asynchronous client/server request-reply mechanisms (remote procedure calls—RPC's) to interact directly with client users through the use of pop-up windows. A RPC is activated when a client user clicks on a URL link that initiates a call to a remote server (MSP or other partner client). This activates the RPC procedure with the MSP (or another partner client). This mechanism is used to buffer sensitive information from partner exchanges. With this RPC procedure, communication regarding proprietary user information is conducted totally outside of any partner exchange. See FIG. 3.

us1/pf4: Valid “MSP Registration” form submission OR valid MSP login.

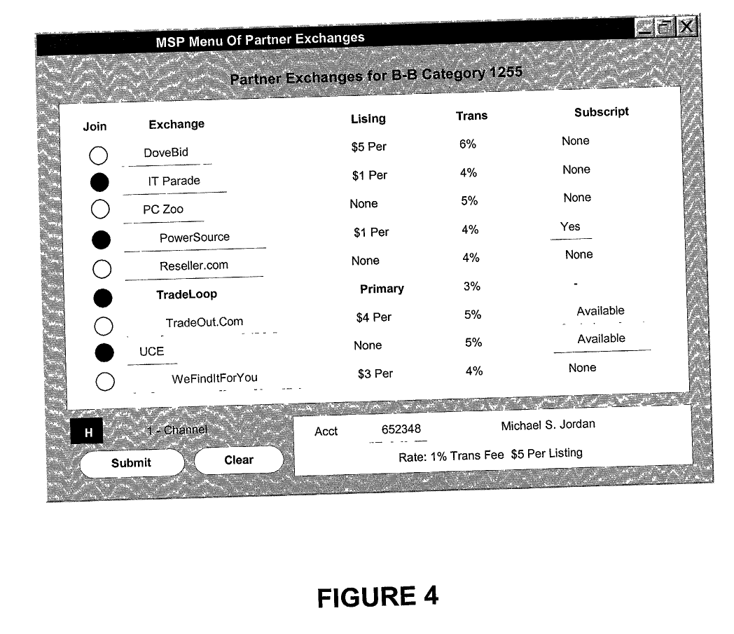

us1/pf5: Primary user presented with “MSP Partner Exchange Menu” pop-up window (window triggered by the successful completion of us1/pf4). See FIG. 4.

us1/pf6: Valid “MSP Partner Exchange Menu” form submission.

us1/pf7c : Primary user presented with “Additional Auction Information” pop-up window (contingent on partner clients chosen AND successful completion of us1/pf6).

us1/pf8c: Valid “Addition auction information” submission (contingent on partner clients chosen).

us1/pf9: “Successful MetaAuction Activation” confirmation pop-up window is presented to primary user. (if us1/pf7c exists, then window triggered by successful completion of us1/pf8c, if not, the successful completion of us1/pf6).

II. Financial Function 1 (ff1/): MSP performs financial clearing functions for all clients and the primary user BEFORE acceptance of bids or offers.

ff1/pf1: The MSP electronically collects and distributes from the primary user all partner client auction fees and the MSP MetaAuction setup fee. The primary client bills the primary user directly for its' auction fee(s) in the normal manner.

NOTE: With a service implementation, a primary exchange may choose to do all the financial clearing functions assumed by the MSP. In this case, the seller would not have to provide payment information to the MSP since the information is already on file with the primary exchange. The primary exchange assumes all ff1/.

III. Trigger Sequence 1 by us1/pf1 (ts1/): MSP Setup of MetaAuction

<tfx=Trigger Function, where x is the sequential function number>

<ts1 concurrent with us1 after us1/pf1>

ts1/tf1: Primary client database converts MetaAuction setup data into an XML document AND enqueues a message for the MSP.

ts1/tf2: Primary client delivers message to MSP message broker queue.

ts1/tf3: MSP message broker dequeues XML document, converts XML to SQL data AND writes the data to the MSP OR/DBMS for analysis.

IV. Trigger Sequence 2 by us1/pf6 OR us1/pf8c (ts2/): Activation of MetaAuction

<tfx=Trigger Function, where x is the sequential function number>

<ts2 by us1/pf6 only if us1/pf7c does not exist, if us1/pf7c does exist, then ts2 by us1/pf8c only>

ts2/tf1: MSP OR/DBMS converts MetaAuction activation data into XML document AND enqueues a message for each chosen partner client.

ts2/tf2: MSP message broker delivers customized messages to each partner client message queue.

ts2/tf3: Each partner client dequeues message, converts customized XML document to SQL data AND writes the data to the client database.

V. User Sequence 2(us2/): Secondary User Submits MetaAuction Bid or Offer

<sfx=Secondary User Function, where x is the sequential function number>

us2/sf1: Secondary user submits a bid (forward auction) or offer to sell (reverse auction) from partner client (bids/offers from primary client ignored and excluded). Client database is updated directly by partner client where the bid/offer submission originates in the normal manner.

us2/sf2: Buyer is presented with a pop-up window from the MSP asking the secondary user to enter his/her email address. This information is used for notification purposes (tn1/sf1) upon acceptance.

NOTE: An alternative method is for the system to query the exchange directly for the e-mail address of the secondary user only after the secondary user becomes accepted by a primary user.

This would be secondary user information disclosure to the system on a “need to know basis.” If this alternative method is used, then the system would not have to ask the secondary buyer to enter his/her email address at this time, thus eliminating step (us2/sf2).

us2/sf3: After successful completion of us2/sf2, partner client database converts bid/offer submission data into an XML document AND enqueues a message for MSP.

us2/sf4: Partner client delivers message to MSP message broker queue.

us2/sf5: MSP message broker dequeues XML document, converts XML to SQL data AND writes the data to the MSP OR/DBMS for analysis.

us2/sf6: MSP OR/DBMS converts bid/offer submission data into a customized XML document for each of the other joined clients (partner clients and primary client, excluding the partner client from which the bid/offer was submitted) and enqueues a message for each of the other joined clients.

us2/sf8: Each partner client dequeues message, converts customized XML document to SQL data and writes the data to the client database.

VI. User Sequence 3 (us3/): Primary user accepts bid or offer from secondary user

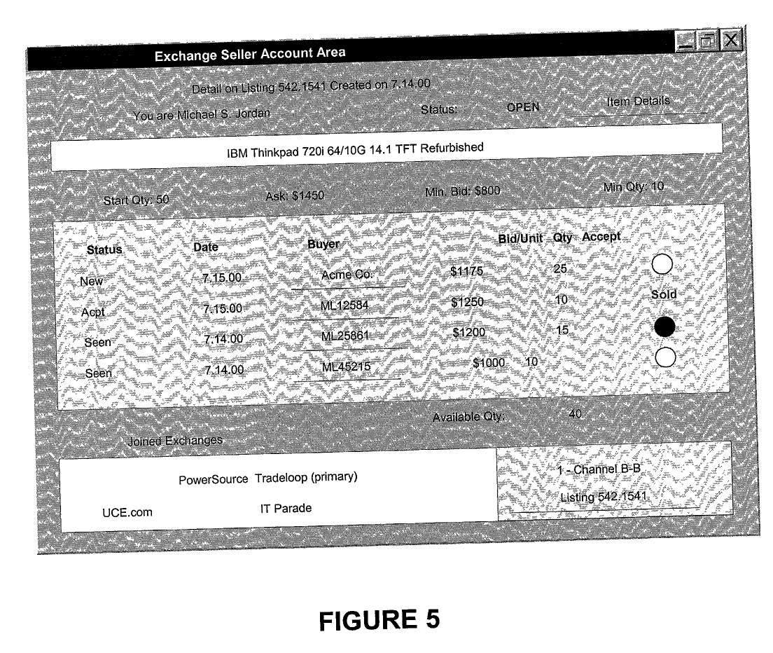

us3/pf1: Primary user accepts a bid or offer from a secondary user on a partner client. Primary clients updates its' internal database in normal manner. See FIG. 5.

us3/pf2: Primary client database converts bid/offer acceptance data into an XML document AND enqueues a message for the MSP.

us3/pf3: Primary client delivers message to MSP message broker queue.

us3/pf4: MSP message broker dequeues XML document, converts XML to SQL data AND writes the data to the MSP OR/DBMS for analysis.

us3/pf5: MSP OR/DBMS converts bid/offer acceptance data into a customized XML document for all partner clients AND enqueues a message for each partner client.

us3/pf6: MSP message broker delivers the customized messages to each partner client message queue.

us3/pf7: Each partner client dequeues message, converts customized XML document to SQL data and writes the data to the client database.

RESULT: Accepted bid/offer from secondary user is displayed on all clients as “Accepted” or “Sold To.” The number of units that is committed to the secondary user reduces the available quantity on all clients by that exact amount.

VII. Triggered Notification 1 by us3/pf1 (tn1/): MSP emails secondary user

tn1/sf1: MSP emails to the “accepted” secondary user the primary user's contact information.

NOTE: Each client handles all other customary user notifications in their normal way.

VIII. MSP Query Sequence 1 (qs1/): Primary user queries MSP for identification of accepted secondary user

qs1/pf1: To obtain the contact information for accepted secondary users not originating on the primary client, the primary user clicks the MetaAuction “Buyer” (identification) link on the primary client's seller area.

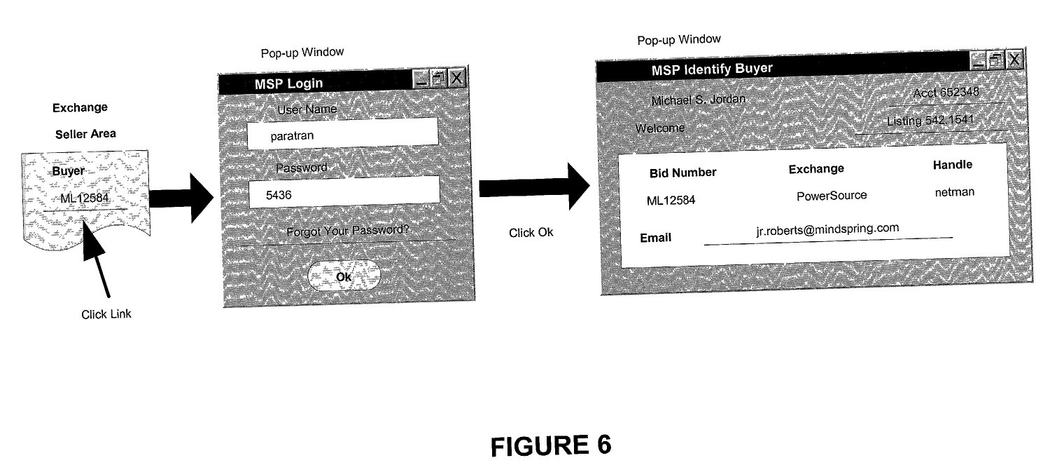

qs1/pf2: The primary user is presented with the “MSP Login” pop-up window triggered by qs/pf1. The primary user is required to enter his/her MSP user name and password. See FIG. 6.

qs1/pf3c: If “Forgot Your Password?” link clicked on “MSP Login” window, then primary user is presented with the “Enter Your Email Address” pop-up window.

qs1/pf4c: Submission of a valid email address for the primary user to the MSP.

qs1/pf5c: MSP emails user name and password to primary user.

qs1/pf6: Valid MSP Login form submission for primary user.

Qs1/pf7: MSP validates that secondary user is accepted. If not, primary user is notified via an MSP error pop-up window that they can obtain the identity of a secondary user ONLY if the secondary user is accepted by the primary user.

qs1/pf7: Upon validation, the primary user is presented with the “MSP Identify Buyer” pop-up window for forward auctions or the “MSP Identify Seller” pop-up window for reverse auctions.

Window are triggered by qs1/pf6. The window(s) gives the primary user the secondary user's email address, originating client, and a nickname or handle if available.

IX. Financial Functions 2 (ff2/): MSP performs financial clearing functions for all clients and the primary user AFTER acceptance of bids or offers.

ff/pf1: The MSP electronically collects and disburses payments among all clients and the primary user. When a primary user accepts a bid/offer from a secondary user on a partner client, the MSP electronically collects the contract transaction fee from the primary user for the partner client. At this time, the MSP also collects its' own transaction fee from the primary user. To reduce the complexity of transaction settlements, the MSP implement a ledger-offset system of credits and debits between all clients. At the end of the day, the net settlement is electronically paid to each client.

NOTE: A primary exchange may assume all ff2/ instead of the MSP.

NOTE: The above user/client interfaces and experiences scenario is based upon the centralized implementation of the service where a MSP creates and manages all MetaAuctions. The other method used by the service is the decentralized approach where the MSP acts as a peer in distributed meta-transactional networks (DMTN's). This occurs when the MSP functions as a “MTN bridge,” joining heterogeneous MTN orientations—centralized-to-decentralized (CMTNto-DMTN) In the DMTN (which is the software implementation of MetaAuctions), each partner client maintains a parallel-synchronized MetaAuction database/application structure.

Communication occurs directly between client partners. The MSP essentially becomes an additional partner client in the DMTN and functions accordingly.

Meta-Infrastructure Methods

There are many combinations of different elements, methods and protocols that can be used to create sufficient meta-infrastructure to form and manage MetaAuctions. The specific expression of elements, methods, and protocols used by the service to achieve meta-infrastructure are indicated in bold.

I. Meta-Infrastructure Elements (all possibilities)

1) Data Interchange Methods (determined by integration method)

a) XML

i) SAX (XML API specification)

ii) DOM (XML API specification)

b) XML based Languages

i) XSL (Extensible Stylesheet Language)

ii) XLL (XML Link Language)

iii) XHTML (XML based HTML)

c) RDF (Resource Description Framework)

d) EDI

e) HTML

f) Object Invocation

g) RPC's (remote procedure calls)

2) Communication Protocols (determined by integration method)

a) Connection Protocols

i) Synchronous (blocked query/response mechanisms)

ii) Asynchronous (deferred and multi-threaded query/response mechanisms)

b) Transportation Protocols

i) HTTP

ii) Web Form

iii) TCP/IP

iv) File Transfer (FTP, NFS, SMB)

v) IIOP

vi) SOAP

vii) XML-RPC

viii) WDDX

ix) ebXML

x) MOM (JMS—JAVA Messaging Service—and other API specifications)

3) Meta-Infrastructure Orientations

a) Centralized (MSP)

b) Distributed (No MSP)

c) Clustered (Joined MTN's)

4) Modes of Implementation

a) Third Party Utility Service

b) Client Managed Service

5) Other Middleware Components Used

a) XML SQL conversion and management utilities

b) XML parsers

II. Distributed Integration Methods (all possible methods)

1) Client-Server

a) Remote Procedure Calls (RPC's)

b) Remote Stored Procedures (RSP's)

2) Distributed Objects

a) CORBA

b) DCOM

c) RMI

3) Message Oriented Middleware (MOM)

a) Messaging and Message Queuing

i) Peer-to-peer delivery method (PTP)

ii) Publish and subscribe delivery method (Pub/Sub)

III. Database Technology

1) Database linking protocols (all standards)

a) ODBC

b) JDBC

c) OLE DB

2) Database Structures

a) RDBMS (Relational)

b) OR/DBMS (Object-Relational)

As indicated in bold in the overview above, the specific meta-infrastructure elements, languages, distributed integration methods, database protocols and API's utilized by the service to create meta-infrastructure for the purpose of forming and managing MetaAuctions is summarized below:

XML (SAX and DOM API protocols), HTML, XSL, XLL, XHTML, RDF and RPC mechanisms are used as the means of data interchange;

synchronous and asynchronous connection protocols using deferred, blocked query/response and multi-threaded query/response mechanisms;

MOM (JMS messaging API specifications and other MOM proprietary API specifications), HTTP, Web Forms, TCP/IP, FTP SOAP, XML-RPC, and ebXML are the transport protocols used; the service operates within centralized, distributed and clustered meta-infrastructure orientations;

a third party utility service is the mode of MetaAuction implementation;

the service uses middleware such as XML SQL conversion and managment utilities and XML parsers;

remote procedure calls (RPC's), remote stored procedures (RSP's), messaging/message queuing (using PTP and Pub/Sub delivery methods) are the methods used to achieve distributed application/database integration;

the service uses ODBC, JDBC and OLE DB database linking protocols; the service uses both RDMBS and OR/DBMS database structures.

Mapping XML Document Structure to Database Structure

In order to transfer data between an XML document and a database (MSP or client), the service maps document structure to database structure and vice versa. The service uses two mapping methods to achieve this: template-driven and model-driven.

Template-Driven Mappings

In the template-driven mapping, there is no predefined mapping between document structure and database structure. Instead, the service embeds commands in a template that is processed by the data transfer middleware (XML SQL utility). The is illustrated in the following example code, in which SELECT statements are embedded in <SelectStmt> elements:

Example CodeA: template-driven mapping

<?xml version=“1.0”?>
<MetaAuctionInfo>

<Intro>The following MetaAuction has bids:</Intro>
<SelectStmt>SELECT Client, MetaAuctionNumber, Start, End

FROM MetaAuctions</SelectStmt>

<Conclude>We hope one of these auctions meets your

requirements </Conclude>
</MetaAuctionInfo>

When processed by the XML SQL utility, each SELECT statement might be replaced by its results, formatted as XML:

<?xml version=“1.0”?>
<MetaAuctionInfo>

<Intro>The following MetaAuctions have bids:</Intro>
<MetaAuctions>

<Client>Tradeloop</Client>
<MetaAuctionNumber>5424.147</MetaAuctionNumber>
<Start>Dec 12, 2000 13:43</Start>
<End>Dec 15, 2000 01:21</End>
</Row>
...

</MetaAuctions>
<Conclude> We hope one of these auctions meets your
requirements </Conclude>

</MetaAuctionInfo>

The service allows the placement of result set values wherever they are called for in the result set—including using them as parameters in a subsequent SELECT statement —rather than simply formatting the results themselves. The service also supports programming constructs such as for loops and if statements and supports parameterization of SELECT statements, such as through HTTP parameters. The service uses template-driven mappings methodology for transferring data from the client's relational database to an XML document.

Model-Driven Mappings

In the model-driven mapping, a defined data model is imposed on the structure of the XML document and this is mapped, either implicitly or explicitly, to the structures in the database and vice versa.

The service uses two models for viewing the data in an XML document. The first of these models the XML document as a single table or set of tables. That is, the structure of the XML document must be similar to the following, where the <database> element does not exist in the single-table case:

<database>

<table>

<row>

<column1>...</column1>
<column2>...</column2>
...

</row>
...

</table>
...

</database>

The term “table” is loosely interpreted to mean a single result set (when transferring data from the database to XML) or a single table or updateable view (when transferring data from XML to the database). If data from more than one result set is desired (when transferring data from the database) or the XML document contains more deeply nested elements than those necessary to represent a set of tables (when transferring data to the database), then the transfer is simply not possible.

The second model used by the service for data in an XML document is a tree of objects, in which elements generally correspond to objects and attributes and data correspond to properties. This model maps directly to object-oriented and hierarchical databases and can be mapped to relational databases using traditional object-relational mapping techniques or SQL 3 object views.

When the service models an XML document as a tree of objects, there is no requirement that elements necessarily correspond to objects. For example, if an element contains only data, such as the MetaAuctionNumber element in the MetaAuction document, it can be reasonably viewed as a property because, like a property, it contains a single, scalar value. Similarly, the service will model elements with mixed or element content as properties.

XML SQL Utility Process

A XML SQL Utility enables the system to:

pass a query to the database and generate an XML document (SAX or DOM) from the results

write XML data to a database table

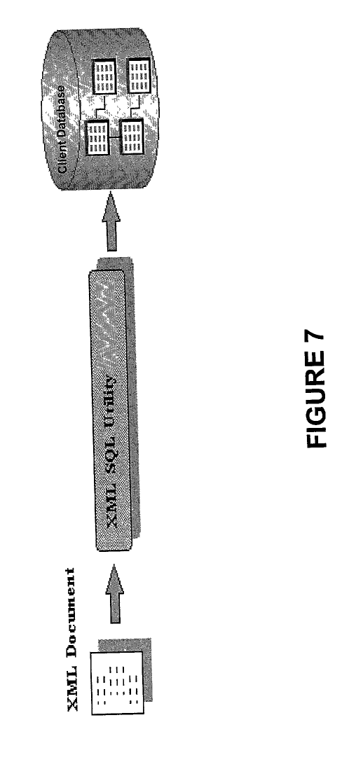

The XML SQL Utility provides the means to store an XML document by mapping it to the underlying object-relational storage, and conversely, provides the ability retrieve the objectrelational data as an XML document. Once stored in the object-relational form, the data can be easily updated, queried, rearranged, and reformatted as needed using SQL. See FIG. 7.

Generating XML from Query Results

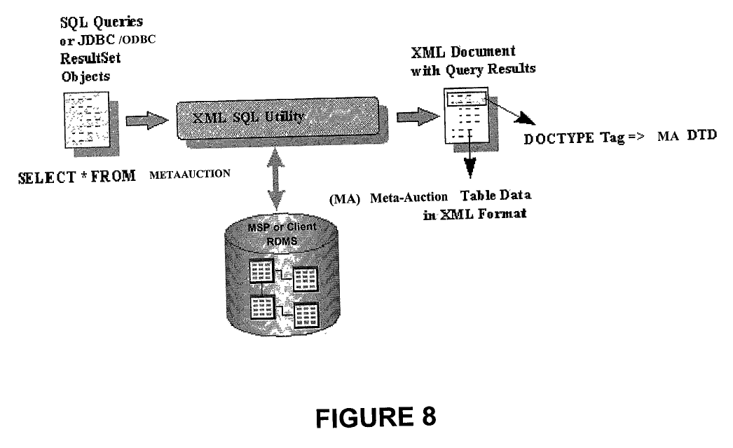

The structure of the resulting XML document is based on the internal structure of the database schema that returns the query results. Columns are mapped to top level elements. Scalar values are mapped to elements with text-only content. Object types are mapped to elements with attributes appearing as sub-elements. Collections are mapped to lists of elements. Object references and referential constraints are mapped to XML IDREFs. A SQL utility can generate either a string representation of the XML document, or an in-memory XML DOM tree of elements. As shown in the figure below, a XML SQL Utility processes SQL queries and return the results as an XML document (see FIG. 8).

The XML SQL Utility is used to generate a DTD (Document Type Definition) based on the schema of the underlying table being queried. The generated DTD is used as input to the XML Class Generator for Java, which will generate a set of classes based on the DTD elements. You can then write Java code that use these classes to generate the infrastructure behind a web-based form. Based on this infrastructure, the web form will capture user data and create an XML document compatible with the database schema. This data can then be written directly to the corresponding database table or object view without further processing.

NOTE: Java products and specifications, Oracle database products, and various other products and specifications are mentioned only for illustration or example purposes. Any language, database, or other products that essentially perform the same function can be used as components in the system.

Example Code1: Generating XML from Query Results and Structuring the Data

Using the XML SQL Utility's API (SAX or DOM), the data presented is constrained in the XML document. For example, the maximum number of rows to return, the number of rows to be skipped, what XSL stylesheet to use, can be specified, among others things.

The following Java code queries an Oracle database and constructs an XML file containing the results. The query is a simple select SUNO (Secondary User Number), SUNAME (Secondary User Name) from MAB (MetaAuction Bid):

```
import java.sql.* ;
import java.math.* ;
import oracle.xml.sql.query.* ;
import oracle.jdbc.* ;
import oracle.jdbc.driver.* ;
public class xmlquerydb
{
  public static void main(String args[]) throws SQLException
  {
```

String tabName = “MAB” ;
String user = “michael/jordan” ;
DriverManager.registerDriver(new

oracle.jdbc.driver.OracleDriver()) ;

//initiate a JDBC connection
Connection conn =

DriverManager.getConnection(“jdbc:oracle:oci8:”+user+“@”) ;

// initialize the OracleXMLQuery
OracleXMLQuery qry = new OracleXMLQuery(conn,“select SUNO,

SUNAME from ”+tabName ) ;

// structure the generated XML document
qry.setMaxRows(2) ; // set the maximum number of rows to be

returned

qry.setRowsetTag(“ROOTDOC”) ; // set the root document tag
qry.setRowTag(“DBROW”) ; // sets the row separator tag
qry.setStyleSheet(“MAB.xsl”) ; // sets the stylesheet
// get the XML document in string format
String xmlString = qry.getXMLString() ;
// print out the XML document
System.out.println(“ OUTPUT IS:\n\”+xmlString) ;

}
}

The resulting XML file returns the first two rows found in the MAB table:

<?xml version=“1.0”?>
<ROOTDOC>

<DBROW id“1”>

<SUNO>7876</SUNO>
<SUNAME>ADAMS </SUNAME>

</DBROW>
<DBROW id=“2”>

<SUNO>7499</SUNO>
<SUNAME>ALLEN</SUNAME>

</DBROW>

</ROOTDOC>

Example Code2: Writing XML to a Database Table

The following Java code inserts the data from the XML file MAB.xml into the MAB table. This example assumes the XML document already conforms to the structure of the MAB table.

```
import oracle.xml.sql.dml.* ;
import java.sql.* ;
import oracle.jdbc.driver.* ;
import oracle.jdbc.* ;
import java.net.* ;
public class xmlwritedb
{
  public static void main(String args[]) throws SQLException
  {
```

String tabName = ”MAB” ; // Table into which to insert XML

data

String filSUNAME = “MAB.xml” ; // XML document filSUNAME
DriverManager.registerDriver(new

oracle.jdbc.driver.OracleDriver()) ;

// Initialize a JDBC connection
Connection conn =

DriverManager.getConnection(“jdbc:oracle:oci8:michael/jordan@”) ;

// Insert XML data from file (filSUNAME) into
// database table (tabName)
OracleXMLSave save = new OracleXMLSave (conn, tabName) ;
URL url = save.createURL(filSUNAME) ;
int rowCount = save.insertXML(url) ;
System.out.println(“ successfully inserted ”+rowCount+

“ rows into ”+ tabName) ;

conn.close() ;

}
}

NOTE: If the system needs to write an XML document to a database table, but the XML data does not match the underlying table structure, the system would have to transform the XML document before writing it to the database.

The Use of XML Parsers

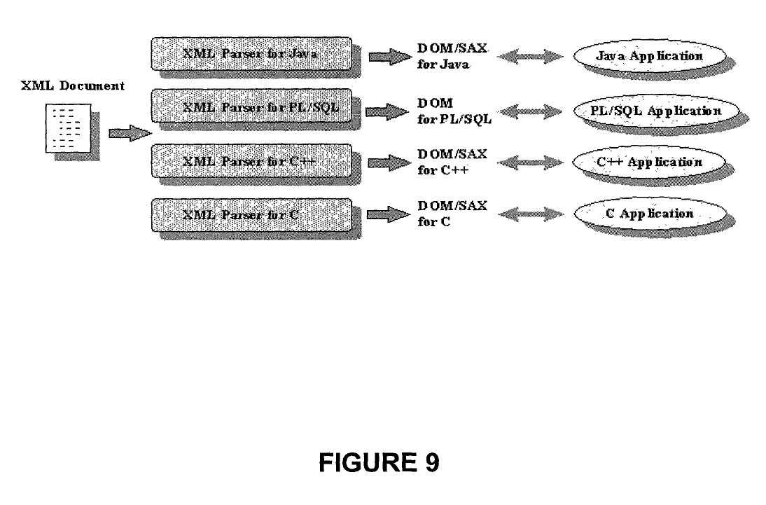

A XML parser is a stand-alone XML component that parses an XML document (or a standalone DTD) so that it can be processed by an application. Parsers typically support both the DOM (Document Object Model) and SAX (Simple API for XML) interfaces, XML Namespaces, validating and non-validating modes, and XSL transformations. See FIG. 9.

An event-based API (such as SAX) uses callbacks to report parsing events to the application. The application deals with these events through customized event handlers. Events include the start and end of elements and characters. Unlike tree-based APIs (DOM), event-based APIs usually do not build in-memory tree representations of the XML documents. Therefore, SAX is used for the XML/Message Queuing system.

Example Code3: XML Parsing

<?xml version=“1.0”?>

<MABLIST>

<MAB>

<SUNAME>MARTIN</SUNAME>

</MAB>
<MAB>

<SUNAME >SCOTT</SUNAME>

</MAB>

</MABLIST>

Becomes a series of linear events:
start document
start element: MABLIST
start element: MAB
start element: SUNAME
characters: MARTIN
end element: MAB
start element: MAB
start element: SUNAME
characters: SCOTT
end element: MAB
end element: MABLIST
end document

Namespaces are a mechanism to resolve or avoid name collisions between element types (tags) or attributes in XML documents. This mechanism provides “universal” namespace element types and attribute names whose scope extends beyond the containing document.

XML is parsed by the system in validating or non-validating modes. In non-validating mode, the parser verifies that the XML is well-formed and parses the data into a tree of objects that can be manipulated by the DOM API. In validating mode, the parser verifies that the XML is wellformed and validates the XML data against the DTD (if any). Validation involves checking whether or not the attribute names and element tags are legal, whether nested elements belong where they are, and so on. The method for the XML/Message Queuing system can be either validating or non-validating.

XML As the Method of Data Interchange

XML is used as a common format for data exchange between MetaAuction applications. Because XML data is self-describing, an application (clients and MSP) can share its data without any predefined knowledge of the applications receiving the data. Applications can share XML data with or without a common Document Type Definition (DTD). However, sharing a common DTD makes exchanging data more reliable and easier to manage. Without a common DTD, applications can exchange XML data, but there is additional processing required to restructure, and in some cases, interpret the data as it is passed from one application to the next.

Data exchange among MetaAuction applications that share a common DTD has the following flow:

1. The sending application generates an XML document based on the common DTD.

2. The sending application sends the XML document to the receiving application.

3. The receiving application parses the XML data, performs its application-specific processing, and writes the data to its database.

4. The receiving application sends the original XML document (or perhaps a newlygenerated one) to other applications (clients) within a joined market.

Exchanging XML Using a Common DTD

Among MetaAuction applications that share a common DTD, the DTD specifies in advance the kinds of XML data elements to expect and the structural relationships between them. The figure below depicts a simple data exchange example. Here, XML data is generated by a XSQL Java Servlet based on queries produced (indirectly) by a primary user creating a new MetaAuction via the client's user interface (seller's area). The XML data is structured based on a common DTD.

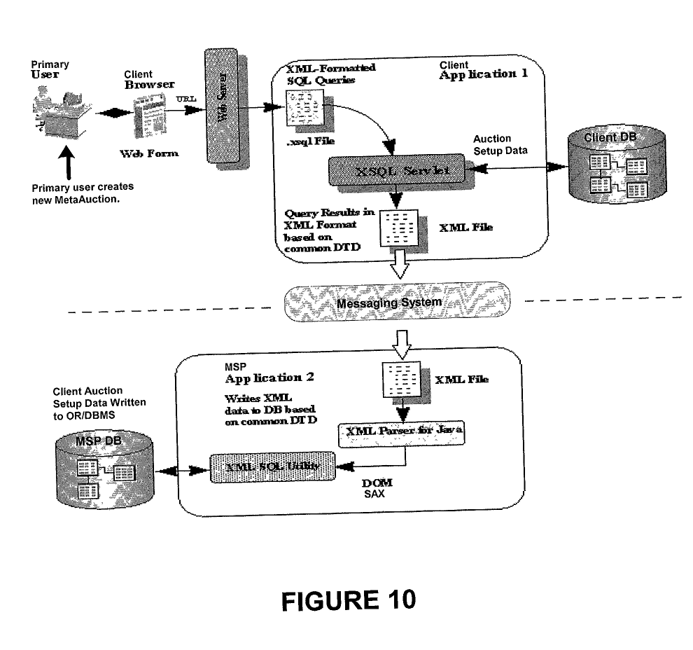

The MSP application receives the data from the client exchange, then parses and processes the XML using a XML Parser for Java, and ultimately writes the XML to its database using the XML SQL Utility. See FIG. 10.

Exchanging XML Without a Common DTD

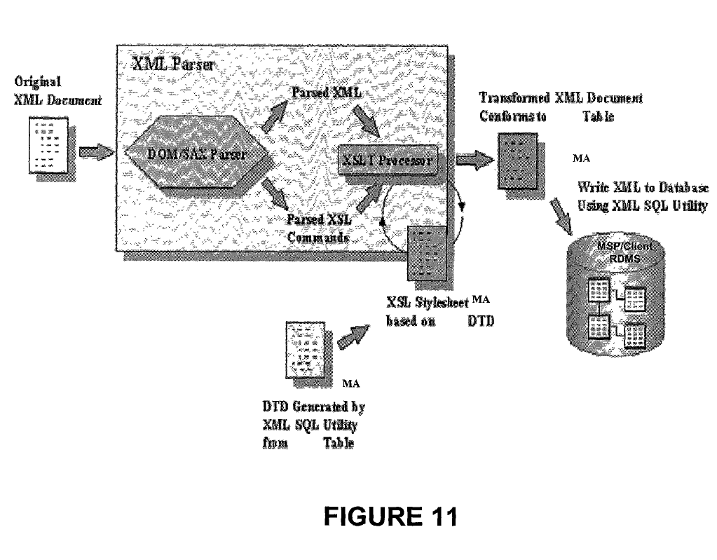

Exchanging XML among client applications that do not share a common DTD requires intermediate processing and transformation of the XML. If the service is required to write XML data to an object view or table, but the XML data does not match the underlying table structure of the target database, the service will need to transform the XML data before writing it to the database. In this case, the service uses an XSL stylesheet to transform the XML document into a new XML document that conforms to the underlying database schema of the target database. One way to determine how to structure the new XML data is to use the XML SQL Utility to query the target object view or table. This generates an XML document and optionally, a DTD for the data that maps to the underlying database schema. See FIGS. 8 and 10. The XML SQL Utility generates the Document Type Definition (DTD) as a separate file, or appended to the generated XML document within the DOCTYPE tag. The service then uses this DTD to design an XSL stylesheet that transforms the original XML document before inserting it into the client or MSP database. This process is illustrated in FIG. 11.

Sending XML Data from a Web Form to a Database

In some cases, the service may obtain auction data from a client application by extracting the data directly from a client's web form and visa versa. In this scenario, the sending client application renders a web form. A user fills out the form and submits the information via an embedded service component (a Java applet or Javascript) running in the browser. The service's embedded applet or Javascript transmits the user's form in XML format to the receiving application, which reads and processes it. Because the receiving application (MSP or another client) will ultimately write data to the database, the sending application would create the XML in a database compatible format. The way the service ensures that data obtained via a client web form will map to the underlying database schema of the MSP or another client is to design the web form and its underlying structure so that it generates XML data based on a schema-compatible DTD. A XML SQL Utility and a XML Parser is used to achieve this. This process has the following flow:

1. The service uses the XML SQL Utility to generate a DTD that matches the expected format of the target object view or table.

2. The service feeds this DTD into a XML Class Generator for the native (Java) language, which builds classes that can be used to set up the web form presented to the user.

3. Using the generated classes, the web form is built dynamically by the service.

4. When a user fills out an auction form and submits it, the service maps the data to the proper XML data structure and the XML SQL Utility writes the data to the MSP database.

The service uses the DTD-generation capability of a XML SQL Utility to determine what XML format is expected by a target object view or table. To accomplish this, the service performs a SELECT*FROM an object view or table to generate an XML result. This result contains the DTD information as a separate file or embedded within the DOCTYPE tag at the top of the XML file. The service then uses this DTD as input to the XML Class Generator to generate a set of classes based on the DTD elements. The service then writes (Java) code that use these classes to generate the infrastructure behind a client's web-based form. The result is that data submitted via the client's web form will be converted to an XML document that can be written to the MSP database.

XML Class Generator for Java

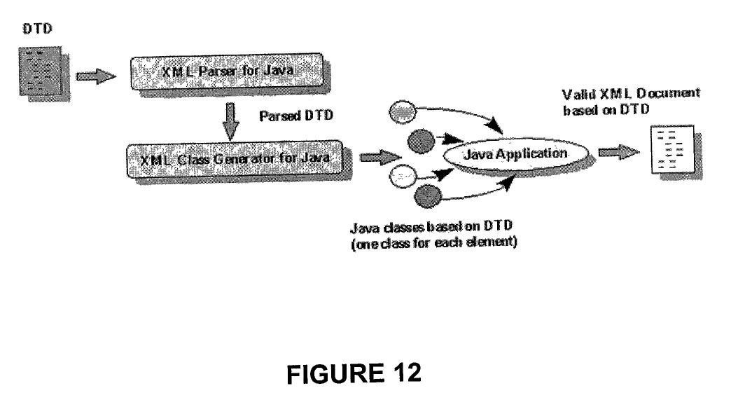

The XML Class Generator for Java (the best know expression of the service process) creates Java source files from an XML DTD. This process is used when a client application wants to send an XML message to another client application based on an agreed-upon DTD or as the back end of a web form to construct and XML document. Using these classes, Java applications can construct, validate, and print XML documents that comply with the input DTD. The Class Generator works in conjunction with the Oracle XML Parser for Java (the best know expression of this process), which parses the DTD and passes the parsed document to the class generator. See FIG. 12.

Example Code3a: XML Class Generator For Java

This example code shows how the XML Class Generator for Java is used by the service to process a DTD and generate classes for the DTD's elements. It also shows how the service programmatically uses methods of the element classes to construct a valid XML document.

The Input DTD

The following DTD file for MetaAuction data, MetaAuction.dtd, is used as the input to the class generator. Here, the DTD specifies that the XML document root is MA and the row element is MA_ROW.MA consists of one or more MA_ROWs. Each MA_ROW contains a required MANO attribute for the MetaAuction number, as well as several optional attributes such as MADESCIPTION for MetaAuction desciptions, AUCTION for auction type, SELLER for primary user, and so on. Optional attributes are followed by a “?” in the element definition:

<!-- DTD for MetaAuction Data -->
<!ELEMENT MA (MA_ROW) *>
<!ELEMENT MA_ROW (MANO, MADESCIPTION?, AUCTION?,
SELLER?, STARTDATE?, ASK?,

TRANSFEE?, CLIENTNO?)>

<!ATTLIST MA_ROW ROWNO CDATA #REQUIRED>
<!ELEMENT MANO (#PCDATA)>
<!ELEMENT MADESCIPTION (#PCDATA)>
<!ELEMENT AUCTION (#PCDATA)>
<!ELEMENT SELLER (#PCDATA)>
<!ELEMENT STARTDATE (#PCDATA)>
<!ELEMENT ASK (#PCDATA)>
<!ELEMENT TRANSFEE (#PCDATA)>
<!ELEMENT CLIENTNO (#PCDATA)>

Example Code3b: Processing the DTD to Generate Java Classes

The following code sample processes a DTD and generates the corresponding classes for elements in the DTD. Running the class generator on the DTD above creates Java classes for each element (MA, MA_ROW, MANO, MADESCIPTION, and so on). The service can then use the methods defined on these classes to create a valid XML document containing MetaAuction data. See FIG. 12.

import java.io. * ;
import java.net. * ;
import oracle.xml.parser. * ;
import Oracle.xml classgen. * ;
import org.w3c.dom.Element ;
public class SampleMain
{

public SampleMain()
{
}
public static void main (String args[])
{

// validate arguments
if (args.length < 1)
{

System.out.println(“Usage: java SampleMain ”+

“[−root <rootDesciption>] <filmadesciption>”) ;

System.out.println(“filmadesciption\t Input file, XML

document or ” +

“external DTD file”) ;

System.out.println(“−root <rootDesciption> Desciption of

the root Element ” +

“(required if the input file is an external

DTD) ”) ;

return ;

}
try // to open the External DTD File
{

// instantiate the parser
XMLParser parser = new XMLparser() ;
if (args.length == 3)

parser.parseDTD(fileToURL(args[2]), args [1]) ;

else

parser.parse(fileToURL(args [0])) ;

XMLDocument doc = parser.getDocument() ;
DTD dtd = (DTD)doc.getDoctype() ;
String doctype_desciption = null;
if (args.length == 3)
{

doctype_desciption = args[1];

}
else
{

// get the Root Element desciption from the XMLDocument
doctype_desciption =

doc.getDocumentElement() .getTagDescription() ;

}
// generate the Java files...
ClassGenerator generator = new ClassGenerator() ;
// set generate transfeeents to true
generator.setGenerateTransfeeents(true) ;
// set output directory
generator.setOutputDirectory(“.”) ;
// set validating mode to true
generator.setValidationMode(true) ;
// generate java src
generator.generate(dtd, doctype_desciption) ;

}
catch (Exception e)
{

System.out.println (“XML Class Generator: Error ” +

e.toString()) ;

e.printStackTrace () ;

}

}
static public URL fileToURL(String sfile)
{

File file = new File(sfile) ;
String path = file.getAbsolutePath() ;
String fSep = System.getProperty(“file.separator”) ;
if (fSep != null && fSep.length() == 1)

path = path.replace(fSep.charAt(0), ‘/’) ;

if (path.length() > 0 && path.charAt(0) != ‘/’)

path = ‘/’ + path;

try
{

return new URL(“file”, null, path) ;

}
catch (java.net.MalformedURLException e)
{

// Can only happen if the file
// protocol were not recognized
throw new Error (“unexpected MalformedURLException”) ;

}

}

}

Example Code3c: Creating a Valid XML Document from Java Classes

The following Java code shows how generated methods are used by the service. Here, two row elements are created: ma_row1 and ma_row2. Elements for each column are also created (mano1, madesciption1, and so on). To build an XML document tree, the various data elements are grouped by assigning them to each row element as tree nodes. Each row element is then added as a node to the document root element MALIST. In this example, classes generated by the class generator are in uppercase.

import oracle.xml classgen. * ;
import oracle xml parser. * ;
public class CreateMetaAuctions
{
public static void main (String args[])

{

try
{

MA MALIST = new MA() ;
DTD dtd = MALIST.getDTDNode() ; // get static from base

document

// New MetaAuction ma_row1
MA_ROW ma_row1 = new MA_ROW(1) ; // create row and

set ROWNO

MANO mano1 = new MANO(“7654.545”) ;
MADESCIPTION madesciption1 = new MADESCIPTION

(“IBM THINKPAD 720I'S”) ;

AUCTION auction1 = new AUCTION(“ASKESMAN”) ;
SELLER seller1 = new SELLER(“7698”) ;
STARTDATE startdate1 = new STARTDATE(“2000-09-28

00:00:00.0”) ;

ASK ask1= new ASK(“1250”) ;
TRANSFEE transfee1= new TRANSFEE (“.05”) ;
CLIENTNO clientno1 = new CLIENTNO(“30”) ;
// New MetaAuction ma_row2
MA_ROW ma_row2 = new MA_ROW(2) ; // create row and

set ROWNO

MANO mano2 = new MANO(“7680.862”) ;
MADESCIPTION madesciption2 = new MADESCIPTION

(“NOTEBOOK”) ;

AUCTION auction2 = new AUCTION(“DUTCH ”) ;
SELLER seller1 = new SELLER(“7566”) ;
STARTDATE startdate2 = new STARTDATE(“2000-04-19

00:00:00.0”) ;

ASK ask2= new ASK(“1200”) ;
TRANSFEE transfee2= new TRANSFEE(“ ”) ;
CLIENTNO clientno2 = new CLIENTNO(“20”) ;
ma_row1.addnode(mano1) ; // Add data as tree nodes to

ma_row1

ma_row1.addnode(madesciption1) ;
ma_row2.addnode(mano2) ; // Add data as tree nodes to

ma_row2

| ma_row2.addnode(madesciption2) ; | |
|---|---|
| ... | |
| MALIST.addNode(ma1) ; | // Add ma_row1 as tree node to |
| | // MALIST doc root |
| MALIST.addNode(ma2) ; | // Add ma_row2 as tree node to |
| | // MALIST doc root |

MALIST.validateContent() ;
MALIST.print(System.out) ;

}

catch (Exception e)
{

System.out.println(e.toString()) ;
e printStackTrace() ;

}

}
}

Example Code3d: XML Document Created by Java Application

The service code above creates an XML document similar to the following:

<?xml version=“1.0”?>
<!DOCTYPE MA SYSTEM “MetaAuction.dtd”>
<MA>
<MA_ROW ROWNO = “1”>

<MANO>7654.545</MANO>
<MADESCIPTION>IBM THINKPAD 720I'S</MADESCIPTION>
<AUCTION>ASKESMAN</AUCTION>
<SELLER>7698</SELLER>
<STARTDATE>2000-09-28 00:00:00.0</STARTDATE>
<ASK>1250</ASK>
<TRANSFEE>.05</TRANSFEE>
<CLIENTNO>30</CLIENTNO>

```
  /MA_ROW>
  <MA_ROW ROWNO “2”>
```

<MANO>7788</MANO>
<MADESCIPTION>NOTEBOOK</MADESCIPTION>
<AUCTION>DUTCH</AUCTION>
<SELLER>7566</SELLER>
<STARTDATE>2000-04-19 00:00:00.0</STARTDATE>
<ASK>1200</ASK>
<TRANSFEE></TRANSFEE>
<CLIENTNO>20</CLIENTNO>

</MA_ROW>
</MA>

XSQL Servlet Implementation

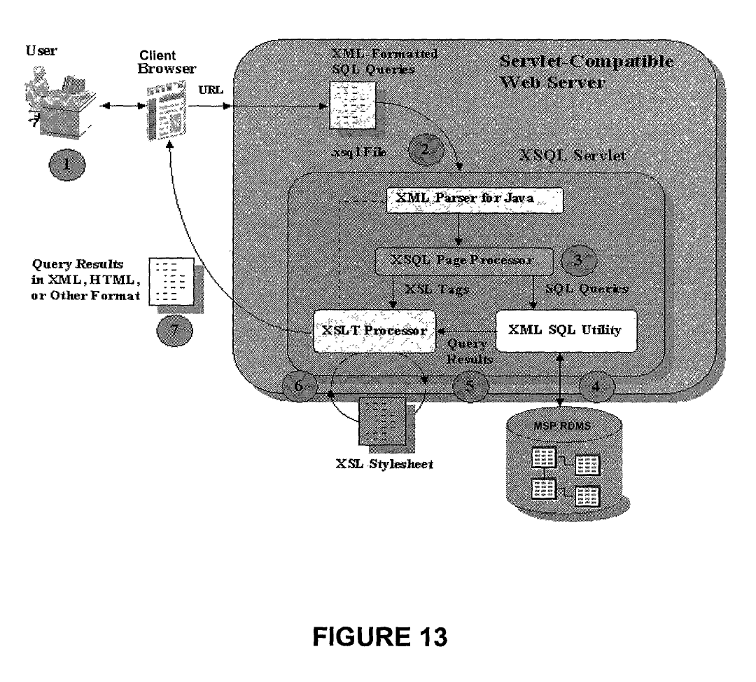

The XSQL Servlet is a service component (the best know expression of the service) that processes SQL queries and outputs the result set as XML. This processor is implemented as a Java servlet and takes as its input an XML file containing embedded SQL queries. It uses the XML Parser for Java and the XML SQL Utility to perform many of its operations. The service executes this servlet in any client web server that supports Java servlets. The following figure shows how data flows from a client, to the servlet, and back to the client. As illustrated in FIG. 13 the sequence of events is as follows:

1. The user enters a URL through a browser, which is interpreted and passed to the XSQL Servlet through a Java Web Server. The URL contains the name of the target XSQL file (.xsq1) and optionally, parameters, such as values and an XSL stylesheet name. Alternatively, the user can invoke the XSQL Servlet from the command line, bypassing the browser and Java web server.

2. The servlet passes the XSQL file to the XML Parser for Java, which parses the XML and creates an API for accessing the XML contents.

3. The page processor component of the servlet uses the API to pass XML parameters and SQL statements (found between <query></query>tags) to the XML SQL Utility. The page processor also passes any XSL processing statements to the XSLT Processor.

4. The XML SQL Utility sends the SQL queries to the underlying MSP database (Oracle) or other client, which returns the query results to the utility.

5. The XML SQL Utility returns the query results to the XSLT Processor as XML formatted text. The results are embedded in the XML file in the same location as the original <query> tags.

6. If required, the query results and any other XML data are transformed by the XSLT Processor using a specified XSL stylesheet. The data is transformed to HTML or any other format defined by the stylesheet. The XSLT Processor can selectively apply different stylesheets based on the type of client that made the original URL request. This HTTP_USER_AGENT information is obtained from the client through an HTTP request.

7. The XSLT Processor passes the completed document back to the client browser for presentation to the user.

Example Code3e: XSQL Servlet

The following service code is a simple XSQL file that queries an MetaAuction table MA. The default behavior of the query is to return all MetaAuction rows in the table. Optionally, a user can narrow the search by adding a find=URL parameter when calling the XSQL servlet from the browser. For example, specifying the letter ‘T’ as the find value will return only those rows whose MADESCRIPTION contains the letter T. Also, users can sort the returned rows by specifying a sort=URL parameter. For example, specifying MANO will sort the rows by MetaAuction number.

<?xml version=“1.0”?>
<?xml-stylesheet type=“text/xsl” href=“rowcol.xsl”?>

<query connection=“demo”

find=“%”
sort=“MADESCRIPTION”
null-indicator=“yes” >
SELECT * FROM MA

WHERE MADESCRIPTION LIKE ‘%{@find}%’

ORDER BY {@sort}

</query>

The XSQL file also specifies that the returned results should be processed using the XSL stylesheet rowco1.xs1. This stylesheet is as follows.

<xsl:stylesheet xmlns:xsl=“http://www.w3.org/1999/XSL/Transform”>
<xsl:tmalate match=“/”>

<html>

<body class=“page”>

<xsl:apply-tmalates/>

</body>

```
  </html>
</xsl:tmalate>
  <xsl:tmalate match=“ROWSET”>
```

<center>
<table border=“0” cellpadding=“4”>
<xsl:choose>
<xsl:when test=“ROW”>

<!−− present headings: row[1] columns +−−>

<xsl:for-each select=“ROW[1]”>

<tr>

<xsl:for-each select=“*”>

<th align=“left”>

<xsl:attribute description=“class”>
</xsl attribute>
<xsl:value-of select=“description(.)”/>

</th>

</xsl:for-each>

</tr>

</xsl:for-each>
<xsl:apply-tmalates/>

</xsl:when>
<xsl:otherwise>

<tr><td>No Matches</td></tr>

</xsl:otherwise>

</xsl:choose>
</table>
</center>

```
  </xsl:tmalate>
  <!−− present rows and columns +−−>
<xsl:tmalate match=“ROW”>
```

<tr>

<xsl:attribute description=“class”>
</xsl:attribute>
<xsl:for-each select=“*”>

<td>

<xsl:attribute description=“class”>
</xsl:attribute>
<xsl:apply-tmalates select=‘.’/>

</td>

</xsl:for-each>

</tr>

</xsl:tmalate>
</xsl:stylesheet>

The System's Message Queuing Component

The system uses a messaging system to communicate MetaAuction XML documents between joined market client applications and the MSP. The sending application transmits the XML document. The receiving application receives the XML document. The messaging system allows separate, uncoupled applications to reliably communicate synchronously and asynchronously.

The messaging system architecture generally replaces the client/server model with a peer-to-peer relationship between individual components, where each peer (client or MSP) can send and receive messages to and from other peers. The messaging component provides a host of powerful advantages over other, more conventional distributed computing models. The messaging system component encourages a “loose coupling” between message consumers (those receiving messages) and message producers (those sending messages). Clients and MSP are both consumers and producers. There is a high degree of anonymity between producer and consumer.

This permits the system to be dynamic, reliable, and flexible, whereby any client or MSP application can be modified without affecting any other client or MSP application. Another advantage of the messaging system includes high scalability (commercial implementations boast the ability to support tens of thousands of clients and tens of thousands of operations per second), easy integration into heterogeneous networks, and reliability due to lack of a single point of failure. A point-to-point protocol is employed within a joined MetaAuction market where messages are routed to individual clients or MSP, each maintaining a queue of “incoming” messages. The MSP message broker sends messages to a specified queue, and the clients retrieve messages from a queue.

Resilience

The service provides multiple forms of resilience for the exchange/auction site applications it services. For example, a sender can indicate that a given message should persist within a brokermanaged data store until all subscribed recipients receive the message. Subscriptions can also be made durable, meaning that a client application will automatically receive messages that are sent to the subscribed topics whenever the client attaches to the message broker—including any persistent messages that may have been sent while the client was off-line. The Service manages the details of the persistence underlying these capabilities. THE MESSAGING SYSTEM specification itself does not prescribe how persistence should be implemented—the implementation design is left to the client.

Flexible Event-Based Mechanisms

The messaging system supports a wide range of system behaviors, from tightly coupled requestreply patterns to loosely coupled scenarios in which the publisher does not care if a given subscriber receives the message. Both the sending and receipt of messages can be either synchronous or asynchronous. For example, a client application may handle message reception synchronously, thereby blocking until a message is received. Alternately, the system messages can invoke asynchronous handlers in the calling application, which then perform operations on behalf of the sender and, optionally, produce a reply. Replies can be sent to temporary unnamed queues for anonymous request-reply scenarios. Hence, the messaging system programming model can be employed as an efficient solution for disparate uses such as a synchronous invocation mechanism for middleware services or the multicasting of MetaAuction information to several clients exchanges.

Transaction Support

The messaging system provides a transaction model, allowing the client application to bundle messages into transactional groups. The broker will hold the transacted messages until the client application either commits the transaction or rolls it back.

Subject-Based Routine

The messaging system transcends the limits of destination-based routing by providing a properties-based message selection mechanism. User-definable properties in message headers can be filtered by the messaging system implementation on behalf of client applications. Selectors are specified using a SQL-like syntax, and can be used to filter information based on a variety of factors. A filter could look for particularly sharp bid drop or increase, for example.

NOTE: The messaging system utilizes a synchronous connection protocol in a query/response fashion to provide users with contact information about buyers and sellers after and during MetaAuctions. The synchronous connection can be made by or through the MSP or directly to the client that has the requested information depending on whether the arrangement is buffered or non-buffered. As an alternative to a synchronous connection via a messaging system, the service may use a synchronous client/server connection to provide users with such information using a query/response mechanism.

The Messaging/Message Queuing Process

The MSP database application sends an XML document embedded within a message to one or more receiving client applications. The receiving applications dequeue the XML message and process it as discussed above. XML messages are sent by client applications to the MSP's message hub. The MSP then dequeus the message and writes the XML data to the MSP OR/DBMS. Through this hub and spoke architecture, XML messages are communicated asynchronously to multiple loosely-coupled receiving client applications. Business Operating Systems (BOS), for example apply this method to inter-business processes in which multiple integration hubs communicate over the Internet backplane (as discussed in the white paper supplement). Examples of other inter-business scenarios that use this same methodology include travel reservations, coordination between manufacturers and suppliers, transferring of funds between banks, and insurance claims settlements, among others.

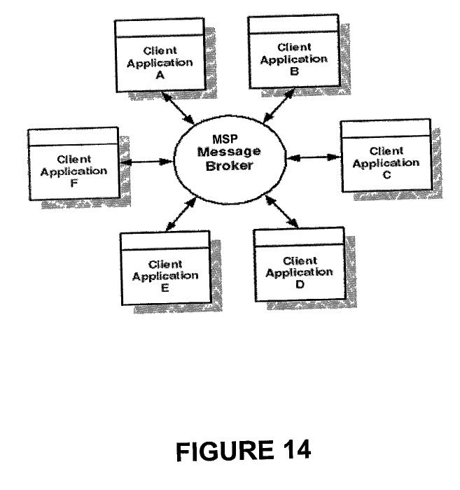

With the XML/Messaging system, all exchange/auction site transactions take place in a loosely coupled environment, where connectivity cannot be guaranteed, where unpredictable latency is the course of the day, where transactions require security, and where the frenetic pace of dynamic commerce demands constant change. Inserting messaging between clients insulates client application code from these issues. The messaging system addresses the demand for a loosely coupled distributed system in a coherent manner. The messaging system architecture is a huband-spoke model, with multiple clients sending and receiving messages to the MSP message broker. See FIG. 14.

NOTE: In certain instances, the service may use a messaging system that does not involve message queuing.

Connection And Session Management

Each client application opens a single connection to the MSP message broker. The connection provides a conduit for communication with the MSP messaging system. Multiple connections are possible, but this would only happen if clients where to connect to multiple MSP message brokers. Within the context of a connection, the client application establishes one or more sessions, each with its own transactional characteristics and acknowledgment modes. All actual messaging activity is performed via the session object. It is considerably more efficient to employ multiple sessions per connection than multiple connections to the same broker. Connections require more resources to establish and maintain than sessions, and can easily be reused for communication through different topics or queues, as well as for different transactional or acknowledgment behavior. Consider the following example using JMS or Java Messaging Service specification:

Example Code4: JMS syntax for creating a session on an established connection

public javax.jms.[Topic|Queue]Session create[Topic|Queue]Session (boolean transacted, int acknowledgeMode)

Where:

transacted is a boolean value; if it is true, the session will be transacted

acknowledgeMode indicates whether the consumer or the client will acknowledge any messages they receive

NOTE: Connection between MSP and clients can be synchronous. In this case, a direct connection would be established between MSP and clients via a synchronous TCP/IP socket connection (secured). This would replace the messaging component with a direct query/response system. See FIG. 14.

Transactional Behavior

Transactional behavior is controlled at the session level. When a session is transacted, the MSP message broker stages the message traffic until the client application either commits or rolls back the transaction. The completion of a session's current transaction automatically begins a new transaction.

The use of transactions affects producers and consumers of messages in the following manner:

Producers:

Commit: The broker sends the set of messages that have been staged

Rollback: The broker disposes of the set of messages that have been staged

Consumers:

Commit: The broker disposes of the set of messages that have been staged

Rollback: The broker resends the set of messages that have been staged

When a rollback is performed in a session that is both a producer and a consumer, its produced messages are destroyed, and its consumed messages are resent.

Acknowledgment Modes

Acknowledgment modes are also controlled at the session level. Acknowledgment is distinct from replies in the request-reply model; they instead inform the message broker that a given client has successfully received a message. Replies, on the other hand, are additional messages sent by a receiver in response to an incoming message. Acknowledgment can be thought of as analogous to handshaking in hardware communication. The messaging systemuses the following acknowledgment modes for receiving messages:

AUTO_ACKNOWLEDGE: The session automatically acknowledges receipt of each message. In asynchronous mode, it indicates that the asynchronous message handler indicated a successful return.

CLIENT_ACKNOWLEDGE: Allows the client application to indicate that it received the message successfully, possibly delaying the acknowledgment.

The application must invoke the acknowledge() method on each message successfully received.

DUPS_OK_ACKNOWLEDGE: A variation on AUTO_ACKNOWLEDGE that provides a lazy mechanism that can result in duplicate message deliveries in failure situations.

While this mode is only appropriate for insensitive data, it provides increased efficiency for the system messaging component.

Messaging Delivery Methods

Point-to-Point

The system uses a point-to-point (PTP) paradigm (also called peer-to-peer), where each session object sends and/or receives through one or more queues (the service also uses a publish and subscribe mechanism as well). Prospective consumers of messages sent to a queue can either receive the message that is first in line (thereby removing it from the queue) or browse through all the messages in the queue, causing no changes. In this PTP paradigm, the first message received by the broker is the first message delivered to a consumer. This FIFO technique requires that the broker retain the second message and any subsequent messages until the first message is consumed. Even when there are no clients associated with a queue, messages are retained. Hence, unlike the pub/sub semantics, durability and persistence are implicit queue concepts for the system. There is only one message consumer for a given message. In some implementations, multiple prospective receivers can attach to a queue, but only one takes delivery of each message. When each message is acknowledged as delivered, the broker disposes of it. No other client sees it and no other client can receive it.

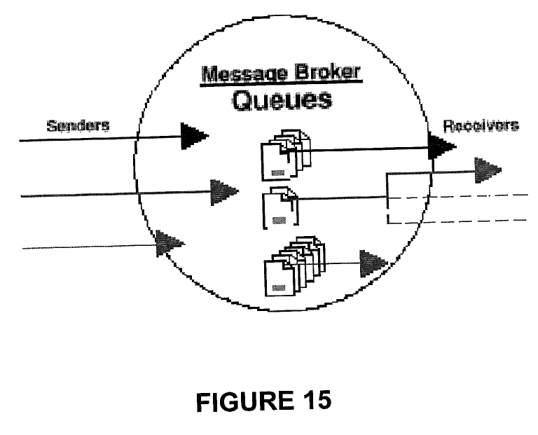

The messaging component specifies a queue browser mechanism. A queue browser allows authorized clients to examine queues (counting messages, for example) without destroying the examined messages. In the figure below, three message queues are shown within a message broker. The queues are shown to have different depths, indicating the stack of messages that are retained until receivers consume them. The receiver could be one of many standing by to receive the first message in the queue. On the middle queue, multiple receivers are attached, but only one will receive the next message: a message queued through PTP is delivered only once. See FIG. 15.

The system's programming model for PTP is virtually identical to that for pub/sub, except for the inherent semantic differences between the two models.

Publish and Subscribe (JMS Implementation)

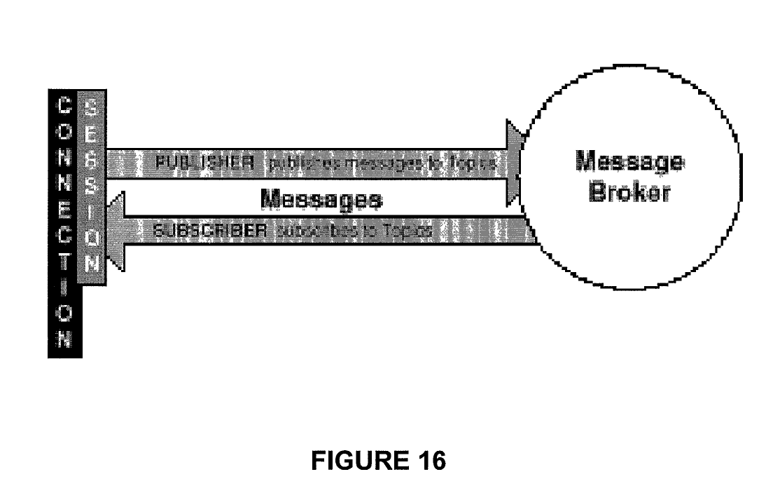

The service also uses a pub/sub delivery mechanism. In the pub/sub paradigm, each session object publishes and/or subscribes to one or more topics. An authorized publisher produces messages through a specified topic, and authorized subscribers receive messages by subscribing to that topic. This model promotes the independence of producers and consumers from one another, and allows for both one-to-many and many-to-many configurations. Topics may be static objects under administrative control, dynamic objects created as needed, or temporary objects created for more transitory or anonymous uses. In order to publish messages, a session must create a publisher object for the selected topic. Likewise, to consume messages published to a topic, a session must create subscriber objects that subscribe to the desired topic. In the figure below, the pub/sub session contains publisher objects producing messages to topics maintained by the message broker and subscribers consuming messages from topics to which the session is subscribed. See FIGS. 15 and 16.

Publishing a message

When publishing a message, the publishing application specifies the quality of service to be used (factors involved here include the message's delivery mode, time-to-live, and priority) as well as whether the subscriber requests a reply:

publish(Message message, int deliveryMode, int priority, long timeToLive)

Where:

message is a javax.jms message

deliveryMode is either NON_PERSISTENT or PERSISTENT

priority is between 0 and 9, with 0 being lowest and 9 highest

timeToLive is between 0 and n, with 0 being forever and any other positive value of n being n milliseconds

Delivery modes

The delivery mode is one of several aspects that determine quality of service for message delivery and receipt:

NON_PERSISTENT: This is the most efficient delivery mode, because it does not require that the message be logged to stable storage. The JMS specification indicates that a JMS provider must deliver a NON_PERSISTENT message with an at-most-once guarantee, meaning that the broker may lose the message (due to a power outage, for example), but it must not deliver it twice.

PERSISTENT: This mode instructs the broker to place the message in a data store as an extension of the send operation. This ensures that the message will survive power outages and other system failures. The JMS specification indicates that a JMS provider must deliver a PERSISTENT message with a once-and-only-once guarantee. It must not lose the message and it must not deliver it twice.

Priority

When several messages await consumption by a subscriber, higher priority messages are presented to the client prior to those of lower priority, resulting in non-FIFO (first in, first out) behavior. See FIG. 16.

Time-to-live

The time-to-live parameter specifies how long the message broker should retain the message in order to ensure that all subscribers receive it. If, after initial delivery, any durable subscribers did not acknowledge delivery, the message is retained for the time-to-live duration in anticipation of those durable subscribers reconnecting to the message broker and accepting delivery. If the time-to-live is specified as zero, the message is said to live forever; it will not expire. When a message's time-to-live is reached, the broker will typically discard it. The JMS specification does not define any form of notification of message expiration. Clients should not receive messages that have expired; however, the JMS specification does not guarantee that message brokers will not allow this to happen. Typically, a message set to live forever will be discarded as soon as delivery to all current subscribers and all durable subscribers is complete.

Nondurable subscriptions

To create a nondurable subscription to a topic, the client application invokes the following method provided by the session object:

TopicSubscriber createSubscriber( Topic topic, String messageSelector, boolean noLocal)

Where:

topic is a string that specifies the name of a topic

messageSelector is a string that defines selection criteria

noLocal is a boolean; a value of true indicates that the client application will not receive messages from subscribed topics that were published locally

Message Selection

Subscribers can filter the messages they receive by qualifying their subscriptions with so-called message selectors. Message selectors cause the JMS provider to evaluate message headers and properties prior to sending messages to the client application. Message selectors employ a syntax based on a subset of SQL-92 conditional expressions. Because the JMS provider handles the filtering, the application and its communication links are more efficient and consume less bandwidth. The following message selector might filter a subscription on a topic to retrieve only high-priority quotes that are requesting a reply:

“Property_Priority>7 AND Property_Type=‘Quote’ AND Property_Reply is NOT NULL”

Durable Subscriptions

To create a durable subscription to a topic, the client application invokes the following method provided by the session object:

TopicSubscriber createDurableSubscriber (Topic topic, String name, String messageselector, boolean noLocal)

Where:

topic is a string that specifies the name of a topic

name is an arbitrary string (not necessarily the username, although that is not uncommon) that indicates the name under which to maintain the durable subscription to the specified topic

messageSelector is a string that defines selection criteria

noLocal is a boolean; a value of true indicates that the client application will not receive messages from subscribed topics that were published locally

A durable subscription indicates that the client wants to receive all the messages published to a topic even if the client connection is not active. The broker ensures that all messages published to the topic are retained until the durable subscriber acknowledges them or the messages have expired.

Example Code4a: Pub/Sub Method

The following code sample illustrates the basic steps required to create a publisher and a subscriber for a sample topic, and publish a message:

String APP_TOPIC =

“sample_topic” ;

//The session method is used to create the topic.
javax.jms.Topic topic =

session.createTopic (APP_TOPIC) ;

//The subscriber uses the session method
//to create a subscriber to it.
javax.jms.TopicSubscriber subscriber =

session.createDurableSubscriber(topic, user) ;

//The subscriber sets a listener for the topic.
subscriber.setMessageListener(myListener) ;
//The publisher uses the session method
//to create a publisher.
publisher = session.createPublisher(topic) ;
// Publish a message to the topic.
private void jmsPublish (String aMessage)
{

try
{

javax.jms.TextMessage msg =

session.createTextMessage() ;

msg.setText (

user + “: ” + aMessage ) ;

publisher.publish( msg ) ;

}
catch ( javax.jms.JMSException jmse )
{

jmse.printStackTrace() ;

{

}

System Messages and Queues

System messages are discrete pieces of XML data exchanged by client and MSP applications. System messages consist of two parts:

The Payload—the XML text data which is self-describing.

Control Information—defines the attributes such as the destination, expiration time, priority, and recipients.

Message management involves tracking messages through the life-cycle, determining the state and location of messages at any given time, tracking the relationship between messages, and exception management. Client and MSP applications interact using message queuing as follows:

1. They create a message and hand it off to the message queuing system.

2. The message queuing system guarantees the delivery of the message to its destination.

3. If the destination is temporarily unavailable for any reason (machine, network, or application failure), the message queuing system stores the message persistently and later forwards it to the destination.

System Queuing is implemented as an integral part of the MSP OR/DBMS. System queues are relational database tables, enhanced to support queuing operations like enqueue and dequeue. Messages are stored as rows in a table, where client and MSP applications use standard SQL to:

Access the payload and control information

Optimize access using indexing methods

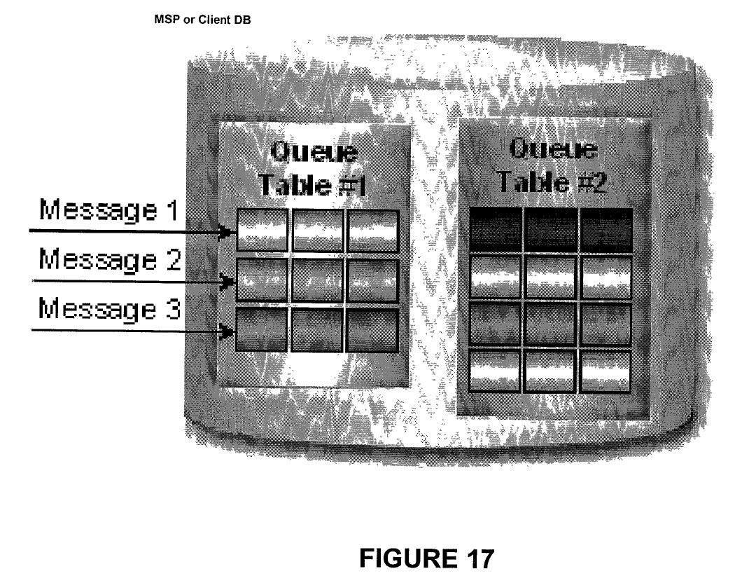

The figure below shows two system queues: Queue Table #1 contains three messages (rows), Queue Table #2 contains four. Each row has columns for message payload, control information, and history. See FIG. 17.

Example Code5: Processing System Messages

The following example code from the system (xm1a2a.sfms.startListening) listens for messages. When it gets a bid modification message, it parses the message using the Oracle XML Parser for Java, then updates secondary user bid in the MSP OR/DBMS accordingly (this example shows the details for the bid update).

public void startListening() {

System.out.println(“ExchangeFusionSystem Started Listening on

the queue . . . ”) ;

String l_status = “START” ;
try {

...

while(!l_status.equals(“FINISH”)) {

// Class xmla2a.utilities.AQHandler imports oracle.AQ.*.
// AQHandler m_handler = null ;
String l_xmlString =

m_handler.dequeueMessage(m_handler.m_reqQueue) ;

ByteArrayInputStream l_bstream =

new

ByteArrayInputStream(l_xmlString.getBytes()) ;

// Create an XML document from the given string.
DOMParser l_parse = new DOMParser() ;
l_parse.setPreserveWhitespace(false) ;
l_parse.setValidationMode(true) ;
l_parse.parse(l_bstream) ;
XMLDocument l_doc = l_parse.getDocument() ;
NodeList

l_mauctions=l_doc.getElementsByTagName(“Mauction”) ;

// Process all mauctions in the XML document.
for( int i=0; i< l_mauctions.getLength() ; i++) {

NodeList l_mauction =

l_mauctions.item(i).getChildNodes() ;

NodeList l_mauctionType =

l_mauction.item(1).getChildNodes() ;

// Find out the request type (Change Bid or New bid)
String l_reguestType =

l_mauctionType.item(0).getNodeValue() ;

if (l_requestType.equalsIgnoreCase(“BID”)) {

...

}
else if(l_requestType.equalsIgnoreCase(“NEW BID”)) {

l_clientID =

Integer.parseInt(l_mauction.item(0).getChildNodes().item(0).getNo
deValue()) ;

String l_mauctionNote =

l_mauction.item(7).getChildNodes().item(0).getNodeValue() ;

changebid(l_clientID, l_mauctionNote ;

}

| } | |
|---|---|
| l_bstream.close() ; | // Close the byte array stream |

}

| | |
|---|---|
| } catch(Exception ex) { | // Trap the Errors |

System.out.println(“Error is ”+ ex.toString()) ;
l_status=“FINISH” ;

}

}

The class xm1a2a.utilities.AQHandler imports oracle.AQ.* to provide some queue-processing methods, and implements methods such as dequeueMessage (shown below).

public String dequeueMessage(AQQueue p_queue) {

| | |
|---|---|
| AQMessage | l_message=null; |
| AQRawPayload | l_rawPayload; |
| AQDequeueOption | l_deqOption; |
| byte [] | l_array; |
| try { | |

// Create a AQDequeueOption object with default options:
l_deqOption = new AQDequeueOption() ;
l_deqOption.setCorrelation(“5810”) ;
// Dequeue a message:
l_message = p_queue.dequeue(l_deqOption) ;
// Retrieve raw data from the message:
l_rawPayload = l_message.getRawPayload() ;
l_array = l_rawPayload.getBytes() ;
return new String(l_array) ;

} catch(Exception e) { // Catch the exception

System.out.println(“Exception :”+ e.toString()) ;
return “Fail” ;

}

}

Example Code6: Handling Messages with a Servlet

The following example code from xm1a2a.sfins.SFMSServlet.service shows the flow of execution when a secondary user on the partner exchange modifies his/her bid on a MetaAuction.

public void software (HttpServletRequest p_request,

HttpServletResponse p_response)
throws ServletException, IOException {

// Set parameters for the servlet response.
p_response.setHeader(“pragma”, “no-cache”) ;
p_response.setContentType(“text/html”) ;
String l_regType = p_request.getParameter(“REQ_TYPE”) ;
String l_clientID = p_request.getParameter(“CLIENT_ID”) ;

if (l_reqType == null) {

...

} else if (l_reqType.equals(“CHANGE_BID”)) {

PrintWriter l_write = p_response.getWriter() ;
p_response.setContentType (“text/html”) ;
try{

m_data = this.fetchBid(l_clientID) ;
// Build HTML form for entering new bid data.
SFMSServletHTML.putChangebidPage(l_write, m_data,

l_clientID) ;

l_write.close() ;

} catch(Exception ex) {

l_write.println(SFMSServletHTML.showErrorPage(ex.toString())) ;

}

} else if (l_reqType.equals(“COMMIT_CHANGED_BID”)) {

PrintWriter l_write = p_response.getWriter() ;
p_response.setContentType(“text/html”) ;
try {

m_updatedData = m_updatedData | |

this.commitChangedbid(p_request) ;

// Build HTML page to display status message.
SFMSServletHTML.genMessagePage(l_write, m_message,“ ”) ;
l_write.close() ;

} catch(Exception ex) {

l_write.println(SFMSServletHTML.showErrorPage(ex.toString())) ;

}

...

} else if (l_reqType.equals(“SEND MAIL”)) {

PrintWriter l_write = new

PrintWriter(p_response.getOutput Stream()) ;

if m_updatedData) {

m_updatedData = false;
this.sendUpdatesMailToCLIENT_SYS() ;
SFMSServletHTML.genMessagePage(l_write,m_message,

“Show RAW XML data”) ;

} else {

m_message=“Mail can be sent only when you have updated ”+

“client information.” ;

SFMSServletHTML.genMessagePage(l_write, m_message, “ ”) ;
}
l_write.close() ; // close the writer object

}

Example Code7: Sending an email notification to a client application

The following example code from xm1a2a.sfns.SFMSServlet.sendUpdatesMailToCLIENT_SYS shows how the SFMS sends email to the client application. It creates an empty XML document, writes an XML document to the message body, then calls xm1a2a.utilities.MailHandler.sendMail to mail the message.

public void sendUpdatesMailToCLIENT_SYS() {

// close Updates XML doc
m_updatesMailDoc.endElement(m_mailRoot) ;
l_mailBody = m_updatesMailDoc.getXMLDocumentString() ;

// Create an empty document.
m_updatesMailDoc = createXMLRoot() ;
// Send updates to the CLIENT_SYS via email.
// MailHandler m_mailHandler
m_mailHandler.sendMail(MailParams.s_client_sysMailID,

MailParams.s_mailServerName,
l_mail.Body) ;

m_message = “Message sent to CLIENT_SYS Successfully.” ;

The following example code from xm1a2a.utilities.MailHandler.sendMail uses the Intemet mail protocol SMTP to send email. It imports key functionality from javax.mail.* and javax.mail.internet.*.

public void sendMail(String p_userName,

String p_hostName,
String p_messageBody) {

try{

java.util.Properties l_props = System.getProperties() ;
l_props.put(“mail.smtp.host”, p_hostName) ;
Session l_session = Session.getDefaultInstance(l_props,

null)

MimeMessage l_message = new MimeMessage(l_session) ;
l_message.setSubject(“SFMS XML Updates”) ;
l_message.setText(p_messageBody) ;
l_message.setRecipients(Message.RecipientType.TO,

InternetAddress.parse(p_userName)) ;

Transport.send(l_message) ;

} catch (MessagingException ex) {

ex.printStackTrace() ;

}

}

Connection-based versus Connectionless Communications

Client/server systems and distributed object systems use a connection-based communications architecture. In order for two applications to communicate, they must establish a dedicated network connection. Therefore both client and server (or user and object) must be available at the same time in order to communicate. The dedicated network connection only supports communication between the one client and the one server.

Message oriented middleware (MOM) systems use a connectionless communications architecture. Applications do not need to establish a dedicated network connection to each other in order to communicate. Instead each application connects to a message bus, an intermediary software provided by the middleware. The message bus is responsible for ensuring that messages are delivered to their intended destinations. Using the message bus, an application can send one message which can be delivered to any number of other applications.

Benefits of connectionless communications

A connectionless architecture enables extremely efficient utilization of networking resources, especially in those circumstances where some information needs to be distributed to a number of different locations.

Synchronous versus Asynchronous

The request/response paradigm used in client/server and distributed object systems is an inherently synchronous connection. A client application requests a service from a server. While the server is processing the request, the client waits for the response and is blocked from doing any other work. But client/server and distributed object systems can support asynchronous requests using threads. To execute a request asynchronously, the client application creates a “request” thread and executes the request from within the thread. The request thread remains blocked while the server processes the request, but the main client thread can continue to process other tasks. Multiple threads can be used to process multiple requests concurrently. The service provides automatic support for asynchronous requests. If an interface is defined as an Asynchronous RPC, The service automatically creates a request thread for the client application.

The send/receive paradigm used in message oriented middleware is an inherently asynchronous connection. When an application sends a message, it only needs to wait for an acknowledgment from the messaging system that the message is being processed. The application is not blocked from performing other tasks while a request is being processed. Multiple messages can be sent at the same time to a number of applications to start parallel concurrent requests. It is never assumed that a request will return a response. If the application wishes to obtain a response, it must explicitly request to receive the response, and it must explicitly state whether or not it is willing to wait for the response.

The Service Benefits From Asynchronous Communications

Asynchronous communications allow an application to process other work while a remote request is being processed. If multiple tasks can be run in parallel, asynchronous communications can dramatically improve the efficiency of the applications. If the remote request is a long-running process, asynchronous communications can improve the usability and overall end user acceptance of the application. End users have been known to become impatient with applications which block activity during processing.

The MSP OR/DBMS Component (The Database/Application)

The MSP utilizes an enterprise distributed database system that creates the necessary metainfrastructureto drive MetaAuctions. In a distributed MTN where the MSP functions as a peer, each partner client within the DMTN has its' own parallel-sychronized MetaAuction database/application where communication occurs directly between partner clients (including the MSP). This system is setup and transparently managed by the MSP, while exchanges are partner participants. One key element is the architecture, which takes the form of an object-relational database management system (OR/DBMS) or a relational database management system (RDMS).

Data is filtered and buffered to protect proprietary user information belonging to individual partner exchanges. The result is a dynamic data pump mechanism that transparently circulates data to and from partner exchanges to reliably facilitate a MetaAuction. The resulting metaecosystem becomes an extended enterprise enabling an entirely new business model.

The key to the MSP OR/DBMS is reliable data replication. The distributed data replication methods used by the service provides high performance without placing a burden on exchange databases and could be constructed so as to not require application changes within exchanges. The process is designed to maximize event information flow, while ensuring consistent delivery to exchanges. The OR/DBMS utilizes asynchronous data replication where target sites (partner exchanges) are updated after the source site (where the event originated) has been modified. The delay in updating the other target sites can be a few seconds or a few hours depending on the implementation. In case a particular system (MSP or partner exchange) fails or is not accessible, asynchronous replication allows MetaAuction activity to continue on primary, secondary and tertiary levels without interruption. The primary level is the “primary exchange” on which a MetaAuction originates; the secondary level is the MSP; tertiary levels are partner exchanges that participate. Eventually, data on all levels is synchronized when access is reestablished, guaranteeing propagation of event data to all participating sites.

Ownership determines the methods and conditions that regulate what data can be updated (modified) on each site (partner exchanges and MSP) and what data is read-only on each site. The MSP OR/DBMS uses a master/slave ownership methodology that allows only data originating on a site to be modified by that site—read/write access (data ownership, workflow ownership and peer-to-peer data replication methods can be used as well). All other participating sites have read only access to this data. The master site is the MSP and the slave sites are the partner exchanges. Examples of data origination would be: (1) a new (or modified) bid is placed by a user (buyer) on partner exchange B or (2) a seller on primary exchange A creates or modifies a MetaAuction. Because the bid was created or modified on exchange B, the data originates on exchange B and can therefore only be modified by exchange B. For the same reason, the seller auction data created or modified on primary exchange A can only be modified by primary exchange A. All other exchanges have read-only access to this data. This type of ownership methodology does not require conflict detection and resolution since only one site can modify data. That is, it resolves the data integrity and update conflict problems associated with the asynchronous communication protocol.

The MSP is the central repository for all MetaAuction data created or modified on any exchange within a MetaAuction. When a MetaAuction is created, the MSP dynamically creates a metarelational database structure (MRDS) within the OR/DBMS for that particular MetaAuction and assigns the structure an identification tracking number (i.e.; MetaAuction 542.1541). However, the MSP must precisely control data ownership, assigning read-write or read-only access to all MetaAuction data for each exchange. To achieve this, workload partitioning is utilized to dynamically assign ownership of data as it is created at the table partition level within the MRDS.

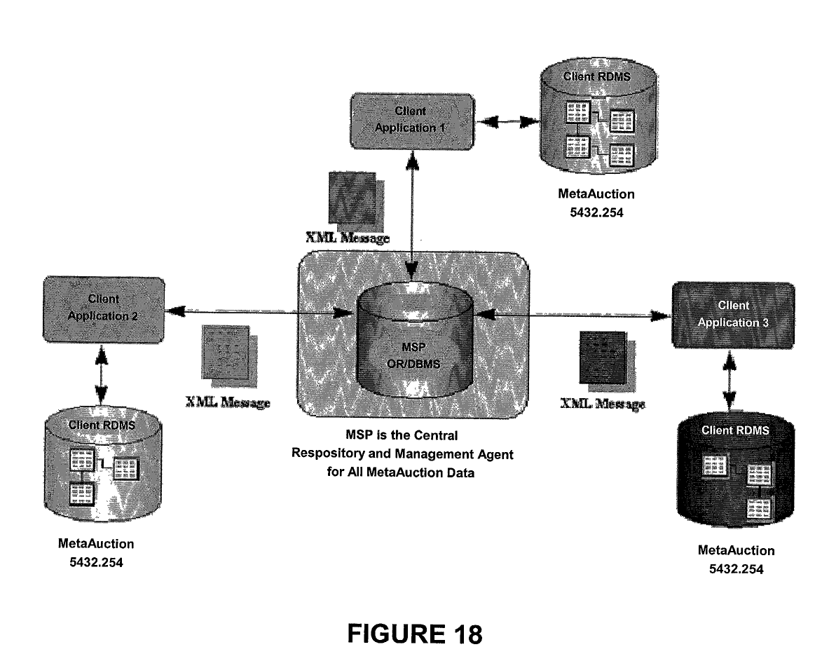

Using the example above, a seller on primary exchange A modifies MetaAuction 542.1541. The replication schema matches the partitioning schema for data created or modified by the seller on exchange A. Exchange A has ownership of it's partitions and can therefore update, insert, and delete auction data within these partitions. Changes are then propagated to the other partner exchanges on a read-only basis via the MSP. On the flip side, exchange A can read MetaAuction data generated on other partner sites, but is not able to update or modify this data because it does not have ownership of the partitions within which this data resides. See FIG. 18.

NOTE: The MSP database/application contains logic and stored procedures that analyze all data to determine what actions are necessary. For example, if a primary exchange sends a message to the MSP (or directly to another partner client in a distributed MTN orientation), containing new MetaAuction setup data, the MSP then proceeds to dispatch the same information to the other participating partner exchanges. That is, internal application logic determines OR/DBMS actions.

Meta-infrastructure Orientations

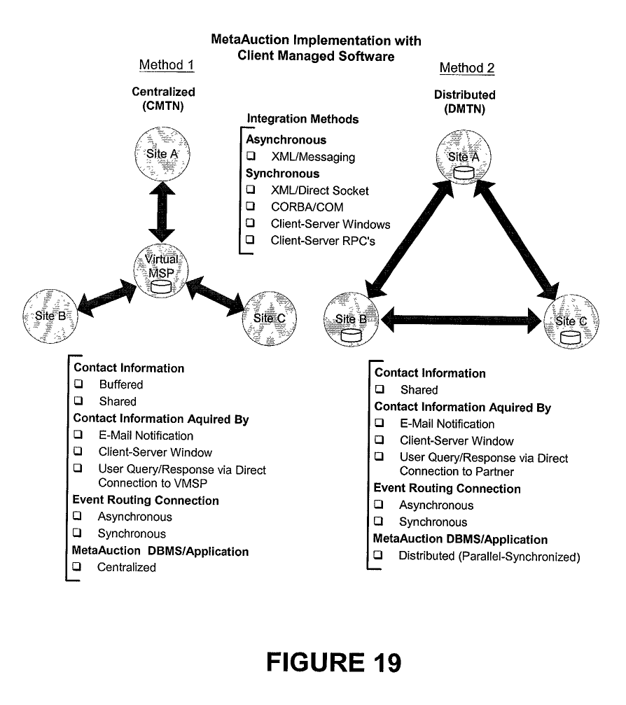

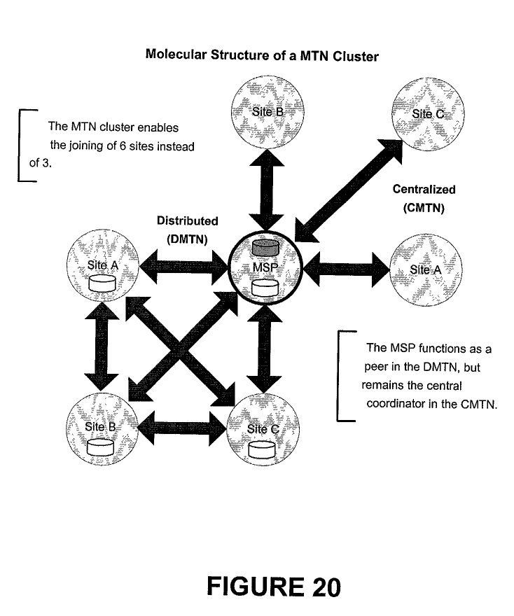

The meta-infrastructure necessary to implement MetaAuctions can be achieved with client managed software. There are two software methods: centralized and distributed. The Centralized method creates a centralized MTN (CMTN) via an artificially intelligent MSP or “virtual MSP” (MSP). This centralized method emulates the same architecture and methods used by public MSP's. Because the CMTN is managed by a MSP, buffering of proprietary user information is possible. The distributed method, by contrast, creates a distributed MTN (DMTN) where each site has a parallel-synchronized MetaAuction DBMS/application. The DMTN does not allow for the buffering of proprietary user information. Integration methods for both methods can be asynchronous or synchronous depending on the level of integration desired. See FIGS. 19 and 20.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A networked system for coordinating the sale of an item to an optimal bidder across a plurality of remote auction services comprising:
a) a networked multi-auction service system comprising:
i) means for communicating with the plurality of remote auction services;
ii) means for detecting a plurality of bids from a plurality of remote auction services;
iii) means for determining which of said plurality of detected bids is the optimal bid;
iv) means for replicating the optimal bid across the plurality of remote auction services;
b) the plurality of networked remote auction services each comprising:
i) means for receiving selling parameters for the item to be auctioned from the multi-auction service or sellers directly;
ii) means for receiving bids for the item to be auctioned from a plurality of bidders and said multi-auction service;
iii) means for updating the bid for the item to be auctioned;
c) a database for storing bid information; and
d) means for converting bids received at the remote auction services to a format suitable for storage in the database and for converting bid information stored in said database to a format suitable for communication to said remote auction services.
